(19) United States
(12) Patent Application Publication
(10) Pub. No.: US 2015/0106369 A1
(43) Pub. Date: Apr. 16, 2015

(54) SYSTEM FOR MESSAGING A USER

(71) Applicant: KONINKLIJKE PHILIPS N.V., Eindhoven (NL)

(72) Inventors: Julian Charles NOLAN, Pully (CH); Melanie Jane WINDRIDGE, Amersham (GB); Joyca Petra Wilma LACROIX, Eindhoven (NL); Cees VAN BERKEL, Hove (GB); Jan TATOUSEK, Eindhoven (NL)

(21) Appl. No.: 14/511,317

(22) Filed: Oct. 10, 2014

(30) Foreign Application Priority Data
Oct. 15, 2013 (EP) 13188695.4

(51) Int. Cl. G06F 17/30; H04L 12/58

(52) U.S. Cl. CPC G06F 17/30867; H04L 51/046
USPC 707/732

(57) ABSTRACT

A system for messaging users is provided that comprises a therapeutic regime datastore arranged to store therapeutic activity information including information on therapeutic activities forming part of a therapeutic regime of a first user, the therapeutic regime of the first user relating to a health condition of the first user and a user datastore arranged to store information on a plurality of second users. A monitor mechanism is provided to monitor the first user to determine if the first user performs a therapeutic activity for which therapeutic activity information is stored in the therapeutic regime datastore and to produce an adherence result for that therapeutic activity based on the determination. An output mechanism is provided to output information to the second users regarding the adherence result, and a receiver mechanism is provided to receive messages from the second users to the first user relating to the adherence result. A ranking processor is provided to assign a ranking score to each of the second users, with the ranking score relating to the likely influence between a said second user and the first user. The output mechanism is arranged to output one or more messages from the second users to the first user in consideration of the ranking scores.

### FIELD OF THE INVENTION

The present invention relates to a system and method for messaging a user.

### BACKGROUND OF THE INVENTION

There are many illnesses that require long term management. For example, a patient with a long term health condition may have a therapeutic regime prescribed by a doctor, that the patient should then adhere to. The therapeutic regime may manage the patient's symptoms, and the objective of the therapeutic regime is to manage the patient's condition and to help to achieve a positive clinical outcome. It will be appreciated that non-adherence with the therapeutic regime may cause the patient's health to deteriorate.

Alternatively, a patient with a long term health condition may require a therapeutic regime that depends on the symptoms. For such patients, it may be necessary to monitor the patient's symptoms, taking appropriate medical action if the patient's symptoms worsen.

An example of a chronic disease cycle is provided in FIG. 1. Such a pattern is common to many long term health conditions.

For a patient with such a chronic condition, assuming that an outright cure is not possible, stability S1 represents the most positive outcome for the patient. When the patient is stable, the patient's symptoms may fluctuate from day to day, but there is no downward trend. Maintaining stability is likely to be the goal of a therapeutic regime aimed at managing a long term health condition.

If the patient's condition worsens (see path P1), there may be an event onset S2. The term “event onset” refers to a moment when the patient becomes unstable, but not yet acute (that is the next state on the circle). The event could be triggered by the patient contracting another illness (e.g. a cold) or by some other cause that worsens the patient's condition. The event might typically be the first signs of the patient's worsening condition manifesting themselves. The event refers here to the unstable state, which requires some intervention to bring the patient back into a stable state. Such intervention can be change of the patient's medication, ambulatory intervention of the physician or in the worst case hospitalization.

After the event onset S2, if the patient's condition is properly managed (e.g. a corrective action is taken), then the patient's condition may improve and the patient might go back to the stability phase S1, via path P2. However, if the patient's condition is not properly managed and/or the patient's symptoms worsen, then the patient may need to be admitted to hospital S3 via path P3. In general terms, the aim of an admission to hospital S3 is to discharge the patient S4 (via path P4) as soon as possible (i.e. to minimize inpatient treatment). After that recovery continues in the recovery step S5 (via path P5), with the aim of the patient becoming stable again (via path P6). Hence, it is desirable to identify the event soon after its onset, because it is likely that as more time that passes, more expensive interventions will have to be used to bring the patient back to the stable state.

Hence, the patient's long term health condition can be visualized in terms of two loops. The first loop involves stability S1 moving to onset S2, and then back to stability S1. This first loop represents an ideal management of an event of instability for a patient with a long term health condition. The second loop involves admission S3, discharge S4 and recovery S5 after the onset. In terms of the drain on resources on a health care system, typically the costs associated with admitting a patient to hospital dwarf the costs associated with maintaining stability.

It is known to provide devices for messaging. For examples, there are web forums in which users can post messages of support for each other. This might be in the form of a user starting a forum thread in which other users can post replies. Such systems present a potentially large number of messages (e.g. replies to a forum thread) to the user, with the messages presented in date order. Hence, with such systems important messages can be missed.

Likewise conventional messaging systems such as email or SMS messages typically present the user with received messages in date order, and again important messages can be missed.

### SUMMARY OF THE INVENTION

It is an object of the invention to provide a system for messaging a user which substantially alleviates or overcomes the problems mentioned above. In particular, it is an object of the invention to provide a system for messaging a user that overcomes the technical shortcomings of known messaging systems.

According to an aspect of the present invention, there is provided a system for messaging, the system comprising: a therapeutic regime datastore arranged to store therapeutic activity information including information on therapeutic activities forming part of a therapeutic regime of a first user, the therapeutic regime of the first user relating to a health condition of the first user; a user datastore arranged to store information on a plurality of second users; a monitor mechanism arranged to monitor the first user to determine if the first user performs a therapeutic activity for which therapeutic activity information is stored in the therapeutic regime datastore and to produce an adherence result for that therapeutic activity based on the determination; an output mechanism arranged to output information to the second users regarding the adherence result; a receiver mechanism arranged to receive messages from the second users to the first user relating to the adherence result; a ranking processor arranged to assign a ranking score to each of the second users, with the ranking score relating to the likely influence between a said second user and the first user; wherein the output mechanism is arranged to output one or more messages from the second users to the first user in consideration of the ranking scores.

In some embodiments, the adherence result could be an indication that the user has performed or not performed a scheduled therapeutic activity.

Using such a system, the first user can be provided with messages (e.g. messages of support) from second users. The ranking of the messages from the second users and the output of the messages in consideration of this ranking ensures that the most important or most relevant messages are given the appropriate attention by the first user. This avoids the technical issue of the user having a great many messages to sift through to get to the important messages. It also helps ensure that important messages are not missed by the user.

As a result, even if a large number of messages are sent to the first user by a large number of second users, the ranking of the second users will ensure that messages from the most important or most influential second users (which may also take into account the context and/or content of the messages) will be displayed to the first user more prominently.

An important benefit of such a system is that messages from the more relevant second users will be output in a more preferential way (e.g. at the top of the list and/or in a bigger font) than messages from less relevant second users.

In some embodiments, the ranking score relates to the likely influence of the said second user on the adherence of the first user to the therapeutic regime. In such embodiments, the first user will be presented with those messages that are most likely to be effective in aiding the first user adhere to the therapeutic regime.

In some embodiments, the monitor mechanism is arranged to determine if the therapeutic activity is subsequently performed by the first user following the output of a said message from one of the second users; wherein the user datastore is arranged to store information on which second users' messages are effective in causing the therapeutic activity to be performed following the output of the messages; and wherein the ranking processor is arranged to assign higher ranking scores to those second users whose messages are effective in causing the therapeutic activity to be performed following the output of the messages. In such embodiments, the adherence result could be an indication that the user has not performed a scheduled therapeutic activity.

As a result, using such embodiments, those second users whose messages are effective in causing the therapeutic activity to be performed following the output of the messages are ranked more highly. This helps to ensure that the messages are ranked in a way that maximizes the chances of the user adhering to the therapeutic regime.

In some embodiments, at least one of the information pertaining the second users to be stored in the user datastore is chosen from: relationships between the plurality of second users and the first user, location proximity between the plurality of second users and the first user, frequency of contact between the each of the second users and the first user, health conditions of the second users, therapeutic activities carried out by the second users, and wherein the ranking processor is further arranged to assign higher ranking scores to those second users with similar health conditions to the health condition of the first user.

In some embodiments, the user datastore is arranged to store information on the relationships between the plurality of second users and the first user, and wherein the ranking processor is arranged to assign higher ranking scores to those second users with closer relationships to the first user.

As a result, using such embodiments, those second users with closer relationships to the first user are ranked more highly. This helps to ensure that the messages are ranked in a way that those from close relations are prioritized.

In some embodiments, the user datastore is arranged to store information on location proximity between the plurality of second users and the first user, and wherein the ranking processor is arranged to assign higher ranking scores to those second users who are proximate or near to the first user.

In some embodiments, the user datastore is arranged to store information on the frequency of contact between the each of the second users and the first user, and wherein the ranking processor is arranged to assign higher ranking scores to those second users with more frequent contact with the first user.

In some embodiments, the user datastore is arranged to store information on health conditions of the second users, and wherein the ranking processor is arranged to assign higher ranking scores to those second users with similar health conditions to the health condition of the first user.

In some embodiments, the user datastore is arranged to store information on therapeutic activities carried out by the second users, and the ranking processor is arranged to assign higher ranking scores to those second users who carry out similar therapeutic activities to the therapeutic activity of the first user.

In some embodiments, the monitor mechanism is arranged to determine how long the first user spends viewing messages from each of the second users, and to store this information in the user datastore; and wherein the ranking processor is arranged to assign higher ranking scores to those second users whose messages are viewed for longer by the first user.

It will be appreciated that if the first user spends a long time viewing a message from a particular second user, then this may be because that first user considers those messages to be important. Ranking such second users more highly helps to ensure that the messages are ranked in a way that those from influential users are prioritized

As a result, embodiments of the invention can use a number of different criteria for the ranking of the second users. It will be appreciated that different embodiments could use any one or combination of these ranking criteria.

In some embodiments, the system further comprises a user input arranged to receive an input from the user indicating how useful the first user found each message from the second users in aiding adherence to the therapeutic regime, wherein said input is used in the determining of the ranking scores. Hence, in such embodiments, the first users can directly influence the ranking of the second users.

In some embodiments, the ranking processor is arranged to assign different ranking scores to the second users depending on the nature of the adherence result. In other words, the ranking can be contextual. This contrasts with conventional messaging systems that do not display messages in different ways depending on their context.

In some embodiments, the ranking processor is arranged to assign different ranking scores to the second users depending on the content of the messages sent by the second users. In other words, the ranking can depend on what the messages say. For example, a message from a second user relating directly to the adherence result could cause that second user to be ranked higher than a second user sending an unrelated message.

In some embodiments, the ranking processor is arranged to compare the ranking scores of those second users for which messages are received with a stored threshold, and wherein if the ranking scores of those second users for which messages are received are below the stored threshold, the output mechanism is arranged to output a message prompt to second users whose ranking scores are above the stored threshold. Hence, the system can actively prompt high ranking second users in order to obtain appropriate messages.

In some embodiments, wherein following the output of the message prompt, if no messages are received from those second users whose ranking scores are above the stored threshold within a predetermined time window, the output mechanism is arranged to output a further message prompt to those second users whose ranking scores are above the stored threshold.

In some embodiments, the system further comprises an activity datastore arranged to store non-therapeutic activity information comprising information on non-therapeutic activities that are considered to have an effect on the impact of the message; wherein the monitor mechanism is arranged to monitor the user to determine if the user is performing one or more non-therapeutic activities for which non-therapeutic activity information is stored in the activity datastore and to produce a monitoring result based on the determination; wherein the ranking processor is arranged to determine when to send the first user the one or more messages from the second users based on the monitoring result, wherein the ranking processor is arranged to compare the monitoring result to a stored parameter; wherein the output mechanism is arranged to time the output the one or more messages from the second users to the first user on the basis of the comparison of the monitoring result and the stored parameter.

In such embodiments, the messages sent by the second users could be reminders or other such message sent to try to encourage the first user to perform the therapeutic activity. For example, the adherence result could be an indication that the user has not performed a scheduled therapeutic activity, and the messages from the second users could be aimed at encouraging the first user to perform the therapeutic activity.

In such embodiments, the system can time the output of the messages based on monitored non-therapeutic activities of the user. By doing this the timing of the output of the messages can be optimized to ensure the maximum chance of the user taking noting of the messages and then performing the missed therapeutic activity.

Such embodiments can therefore act as a reminder system, with the reminders coming from the second users. Hence, such systems provide tailored reminders that are sent at the most appropriate time. It is known that people are more likely to do something that they are reminded about a task when they are not distracted or doing something else. Such embodiments of the present invention send messages when a user is most likely to be receptive to carrying out the therapeutic activity.

Hence, such embodiments provide the advantage that the messages (which could be acting as reminders) are provided at the most opportune time for the therapeutic activity, based on the non-therapeutic activities of the user at the time. In some embodiments, this is done by delivering the message when the user is carryout out (or not carrying out) certain non-therapeutic activity activities that are considered to have a positive or negative effect on the efficacy of the message. This enables embodiments of the invention to provide greatly improved reminders when compared to conventional systems that simply provide reminders at an absolute preset time. Such embodiments can be used to ensure that the reminder is delivered when the user is likely to be receptive to the reminder.

In some embodiments, the impact of the message relates to the likelihood of the first user performing the therapeutic activity.

In some embodiments, the stored parameter is a threshold, and the output mechanism is arranged to output the one or more messages from the second users to the first user when the monitoring result meets or exceeds the threshold.

In some embodiments, the monitor mechanism is arranged to monitor each activity in the activity information, and to assign an activity score based on whether that activity is being performed.

In some embodiments, the monitoring result is the sum of the activity scores, optionally wherein the monitor mechanism is arranged to assign different weight values to different activities scores.

In some embodiments, the output mechanism comprises a number of devices capable of outputting the messages to the first user, and wherein the ranking processor is arranged to determine which of the said devices to use to output each message to the user based on the therapeutic activity to which each message relates to.

In some embodiments, the ranking processor is arranged to use the communications method used by the second users to send messages to the first user in the ranking.

In some embodiments, the therapeutic regime datastore is arranged to store information relating to a psychological profile of the first user, and wherein the ranking processor is arranged to use the psychological profile of the first user to rank the second users.

In some embodiments, the ranking of the second users can be determined based on the delivery modes that second user has available and the match these have with the psychological profile of the first user (e.g. more personal delivery vs. less personal delivery) as well as and the relationship he has with the patient and the communication style he has.

In some embodiments, the user datastore can be arranged to store information on the psychological profiles of the second users. In some embodiments, the ranking processor can use the psychological profiles of the second users to determine the ranking. For example, ranking processor could use the psychological profile of the first user and the psychological profiles of the second users to determine the ranking.

In some embodiments, the ranking processor could use the psychological profile of the first user, the psychological profiles of the second users, and the communication method used by (or available to) the second users to determine the ranking.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 shows a schematic of a cycle of patient condition and treatment states during the chronic disease;

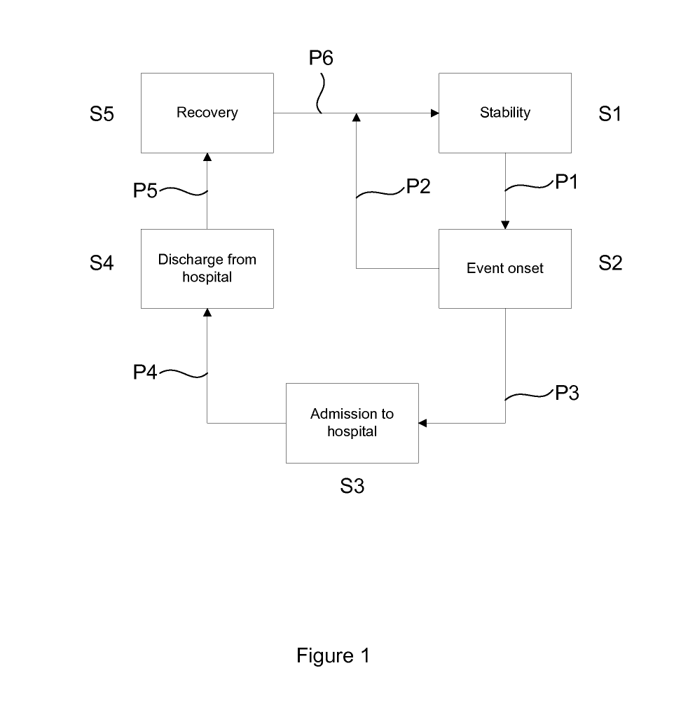

FIG. 2 schematically shows a system for monitoring a user according to a first embodiment of the invention;

FIG. 3 shows a flow diagram explaining the operation of the system of the first embodiment;

FIG. 4 shows a flow diagram explaining the operation of the system of a second embodiment;

FIG. 5 schematically shows a system for messaging a user according to a third embodiment of the invention;

FIG. 6 shows a flow diagram explaining the operation of the system of the third embodiment;

FIG. 7 shows a user interface for use in the third embodiment;

FIG. 8 schematically shows a system for messaging a user according to a fourth embodiment of the invention;

### DETAILED DESCRIPTION OF THE EMBODIMENTS

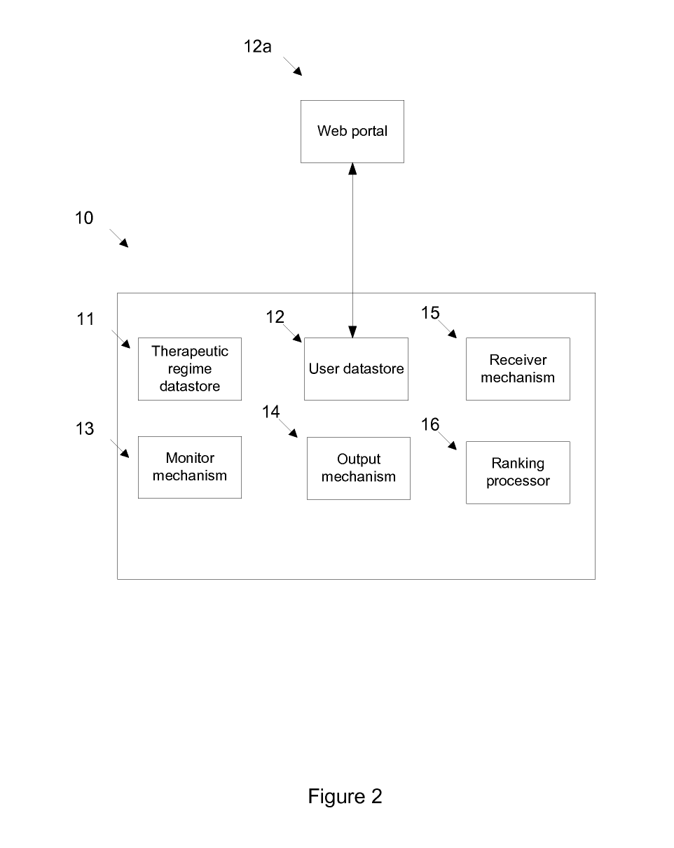

FIG. 2 schematically shows a system 10 for messaging a user according to a first embodiment of the invention. In this embodiment the system could be used by a first user with a long term health condition, with the first user having a therapeutic regime comprising a number of therapeutic activities that the user should perform to adhere to the therapeutic regime.

The system 10 comprises a therapeutic regime datastore 11, a user datastore 12, a monitor mechanism 13, an output mechanism 14, a receiver mechanism 15, and a ranking processor 16.

The therapeutic regime datastore 11 is arranged to store therapeutic activity information including information on therapeutic activities forming part of the therapeutic regime of the first user.

The user datastore 12 is arranged to store information on a plurality of second users. The second users in this embodiment are other users who may wish to send messages (e.g. messages of support or encouragement) to the first user regarding the first user's therapeutic regime. In this embodiment, the user datastore 12 is associated with a web portal 12a that can display information to second users.

The monitor mechanism 13 is arranged to monitor the first user to determine if the first user performs a therapeutic activity for which therapeutic activity information is stored in the therapeutic regime datastore. The monitor mechanism 13 is also arranged to produce an adherence result for that therapeutic activity based on the determination. Hence, the monitor mechanism 13 can determine if the first user adheres or does not adhere to the therapeutic regime by determining if the therapeutic activities in the therapeutic regime are performed.

The output mechanism 14 is arranged to output information to the second users regarding the adherence result. As will be discussed in more detail below, the output mechanism 14 can output information to the second users indicating whether the first user did or did not perform the therapeutic activity. In this embodiment, the output mechanism 14 is arranged to output the information to the second users regarding the adherence result using the web portal 12a via a suitable network (not shown), so that the second users can view the information regarding the adherence result via the web portal 12a. Other embodiments can use other ways of outputting the information regarding the adherence result to the second users (e.g. email or other suitable messaging means).

The output mechanism 14 is also arranged to output messages received from the second user to the first user. In this embodiment, the output mechanism 14 is arranged to output the messages to the first user using a display. Hence, in this embodiment, the output mechanism 14 comprises a display. Other embodiments can use other ways of providing a message to the user.

The receiver mechanism 15 is arranged to receive messages from the second users to the first user relating to the adherence result. For example, as discussed in more detail below, the received messages could be messages of support or encouragement from the second users to the first user.

The ranking processor 16 is arranged to assign a ranking score to each of the second users, with the ranking score relating to the likely influence between the second users and the first user. In this embodiment, the ranking score relates to the likely influence of the said second user on the adherence of the first user to the therapeutic regime. In this embodiment, the likely influence between the second users and the first user may be measured quantitatively, based on at least one of a number of different factors relating to the interaction and interrelationship of the first user and a second user. The likely influence is representative of how influential a second user is on the first user, for example in terms of encouraging the first user to perform a certain task. The likely influence may be determined by considering an influence score for each of the number of different factors relating to the interaction and interrelationship of the first user and a second user. The ranking score may then in turn determined by taking all these different influence scores into account.

Hence, in such embodiments, the first user receives messages from the second users relating to the adherence result. As discussed in more detail below, in this embodiment, the messages are output to the first user in consideration of the ranking scores, so that messages from the most influential second users are ranked higher than messages from less influential second users. By doing this the first user is provided with messages (for example messages of support or encouragement) ranked according to how likely the messages are to be effective.

This helps ensure that the first user can be provided with messages (e.g. messages of support) from second users. The ranking of the messages from the second users and the output of the messages in consideration of this ranking ensures that the most important or most relevant messages are given the appropriate attention by the first user. This avoids the technical issue of the user having a great many messages to sift through to get to the important messages. It also helps ensure that important messages are not missed by the user.

In this embodiment, the therapeutic regime datastore 11, user datastore 12, monitor mechanism 13, output mechanism 14, receiver mechanism 15, and the ranking processor 16 are provided on the same apparatus. For example, such an apparatus could be a smart phone, tablet, general purpose computer or other suitable apparatus. In other embodiments, the apparatus may communicate with external additional monitoring mechanisms. Also, in other embodiments, the elements of the system could be provided on different devices.

In some embodiments, the monitor mechanism 13 can have local components distributed across several devices. Those could either communicate with a local control unit (represented by one of the monitoring devices or by a separate device) or with a remote system or both of these approaches can be combined in one system. In some embodiments, the monitor mechanism 13 can have a form of a remote system (e.g. web server) accessed by the user using a local terminal (e.g. computer, smartphone, tablet etc.), for instance for questionnaire based user monitoring.

In some embodiments, the monitor mechanism 13 can be in the same device as the output mechanism 14 or in separate devices (i.e. one device monitors the first user and another device displays messages to the first user).

In some embodiments, the monitor mechanism 13 and/or the output mechanism 14 can be in the same device as the user datastore 12 or in separate devices (e.g. one device monitors the first user and another device stores information on the second users).

Furthermore, in some embodiments, the output mechanism 14 can have local components distributed across several devices. For example, one component could display a visual message, while another component could play an audible component. In some embodiments, the output mechanism 14 can display the messages from the second user via a number of different mechanisms, e.g. via a number of different local components.

In some embodiments the monitor mechanism 13 can actively monitor the user. In other embodiments the monitoring of the can be based on self-report in which the monitor mechanism 13 could rely on the user's input to determine if the therapeutic activity is performed. In other embodiments, the monitor mechanism 13 can rely on a combination of both.

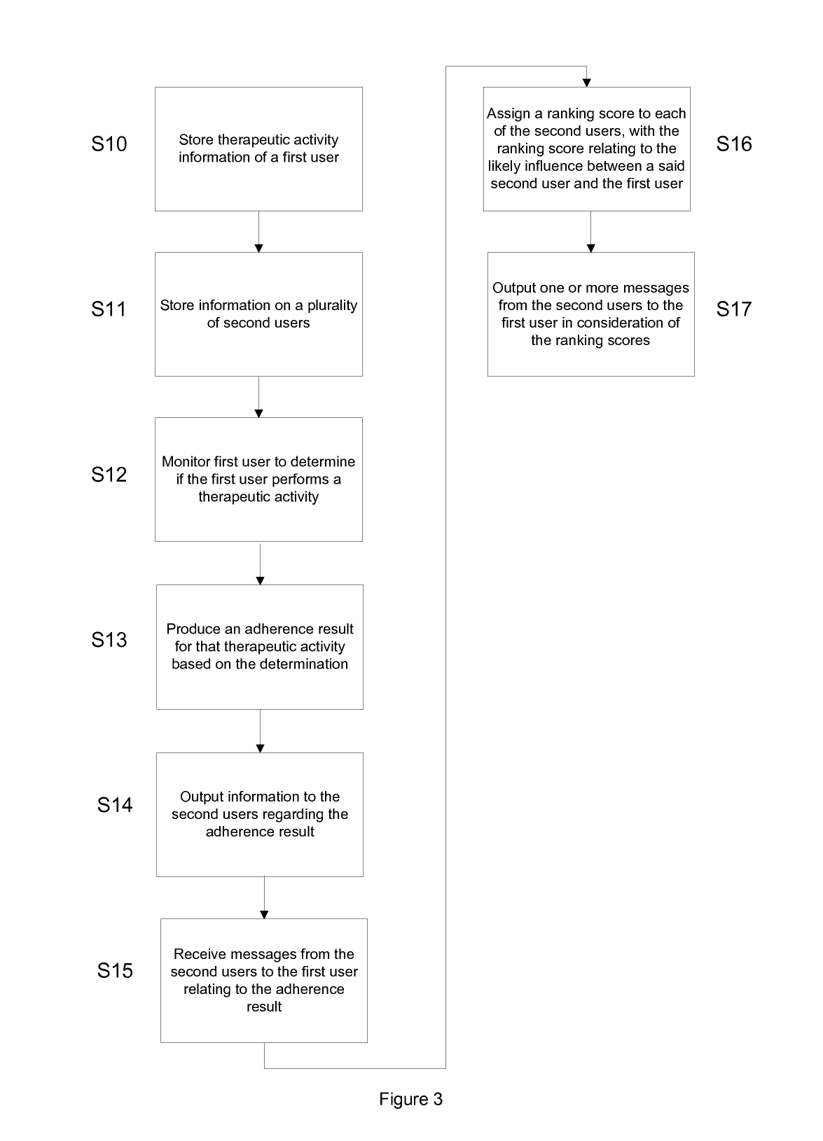

FIG. 3 shows a flow diagram explaining the operation of the system 10. In this explanation, as an example, a first user with Crohn's disease will be considered.

Crohn's disease is an autoimmune disease, and patients typically take oral medication. A contemporary and very powerful treatment involves biologics, which have to be self-injected typically every two to three weeks. Failure to do so, i.e. longer gaps between injections or stopping the injection in symptom-free periods leads to reactivation of the disease as a result of excessive TNF-alpha particles in blood causing inflammatory reactions of sensitive body tissues. This causes the affected body parts (for Crohn's disease these are intestines) to be gradually damaged by the inflammation and lose their function, requiring surgical intervention.

In step S10 of FIG. 3, the system 10 stores therapeutic activity information of the first user in the therapeutic regime datastore 11. In this example, the first user with Crohn's disease has a therapeutic regime that comprises the therapeutic activity of self-injecting biologics every two weeks. Hence, the therapeutic regime datastore 11 stores that the first user must self-inject biologics every two weeks.

In this example, the therapeutic regime datastore 11 stores that biologics must be self-injected at intervals of 13-15 days (i.e. two weeks plus or minus a day). Hence, once the user has self-injected one set of biologics, the therapeutic regime datastore 11 will indicate that the biologics should be self-injected in a time window of 13 to 15 days. If the therapeutic activity of self-injecting the biologics is carried out before 13 days, then the therapeutic regime is inefficient. If the therapeutic activity of self-injecting the biologics is carried out after 15 days, then the therapeutic regime is ineffective. In this example, adherence to the therapeutic regime means self-injecting the biologics at intervals of 13-15 days.

In this embodiment, the system 10 determines the therapeutic activity information using data from a healthcare professional. In some embodiments, the therapeutic activity information could be determined via a questionnaire or by other means.

At step S11, the system 10 stores user information on a plurality of second users. The second users in this embodiment are other individuals that may wish to send messages to the first user regarding the first user's therapeutic regime. For example, the second users could include friends and family of the first user. The second users could also include other users that share the same or similar health condition as the first user, or other users that have a different health condition to the first user, but that need to carry out the same or similar therapeutic activities as the first user.

In this embodiment, the system 10 obtains the information about the second users from the web portal 12a via a suitable network (not shown). The web portal 12a obtains information provided by the first user on their friends and family, and information on the relationship between the second users and the first user is stored in the user datastore 12.

In this embodiment the user datastore 12 also stores details of other users, who do not have a pre-existing relationship with the first user. Such details include, in this embodiment, details of relevant health conditions of the users. This information can be provided via the web portal 12a. Hence, the system 10 can, via the user datastore 12, determine which other users have the same or similar health conditions to the first user. The system 10 could also, via the user datastore 12, determine which other users need to carry out the same or similar therapeutic activities as the first user. The similarity of health conditions may be determined by establishing whether two health conditions belong in a same category, for example pulmonary, coronary, etc., and/or by comparing the number of shared symptoms between two health conditions. It would be appreciated that there many other ways in the relevant art for determining similarity of health conditions.

It will be appreciated that two users may have different health conditions, but need to carry out similar therapeutic activities. For example, there are a number of different conditions that require the therapeutic activity of self-injection. Hence, a first user who is struggling (for example for physiological reasons) with the therapeutic activity of self-injection for their Crohn's disease could find comfort from a message of support from a user who has overcome such difficulties in the therapeutic activity of self-injection—even if the other user needed to self-inject for a different reason.

In this example, the “second users” are selected by the system 10 to include those other users who are friends and family of the first user, those other users who have Crohn's disease, and those other users who need to self-inject as part of a therapeutic regime. It will be appreciated that for a large number of users stored in the user datastore 12, the numbers of such “second users” (i.e. friends and family, as well as those with similar health conditions/therapeutic activities) may be large.

Hence, it will be appreciated that in some embodiments, the number of second users (i.e. those other users who receive details of the therapeutic activities of the first user) may be limited. For example, in some embodiments, the number of other users with similar health conditions/therapeutic activities could be limited by imposing a geographical restriction (e.g. those who live within 10 miles) or using some other type of filter. Such filtering of the users with similar health conditions/therapeutic activities could be done in a number of ways.

In other embodiments, all potential users of the system could receive details of the therapeutic activities of the first user, and the ranking processor 16 (discussed in more detail below) could be used to rank the messages from the second users in a suitable way to ensure that the most relevant messages are displayed more prominently to the first user. As a result, even if a large number of messages are sent to the first user by a large number of second users, the ranking of the second users will ensure that messages from the most important or most influential second users (which may also take into account the context and/or content of the messages) will be displayed to the first user more prominently.

It will be appreciated that although step S11 is shown after S10, this is purely for convenience of illustration. The system 10 could store the therapeutic activity information before, after or simultaneously as it stores the user information on a plurality of second users.

In this embodiment, the output mechanism 14 outputs reminder information to the first user in the time window (i.e. 13-15 days since the last self-injection) to carry out the therapeutic activity.

At step S12, the monitor mechanism 13 monitors the first user to determine if the first user performs a therapeutic activity for which therapeutic activity information is stored in the therapeutic regime datastore. In this example, the monitor mechanism 13 receives a user indication from the first user when the user has self-injected the biologics.

At step S13, the monitor mechanism 13 produces an adherence result for that therapeutic activity based on the determination in step S12.

In this example, if the user has self-injected the biologics at the correct time (i.e. at intervals an interval of 13-15 days) since the previous self-injection, then the adherence result will indicate that the first user correctly performed the therapeutic activity, and that the first user is thus adhering to the therapeutic regime. In this example, if the user has self-injected the biologics too early (i.e. before 13 days) since the previous self-injection, then the adherence result will indicate that the first user incorrectly performed the therapeutic activity, and that the first user is thus not adhering to the therapeutic regime. Furthermore, if it is more than 15 days after the last self-injection and the monitor mechanism 13 has not received a user indication from the first user that the user has self-injected the biologics, then the monitor mechanism 13 can determine that the first user is late with the self-injection, and thus is not adhering to the therapeutic regime.

Hence, in this example, the adherence result can indicate: 1) that the first user correctly performed the therapeutic activity; 2) that the first user incorrectly performed the therapeutic activity by self-injecting too early; 3) that the first user incorrectly performed the therapeutic activity late by missing the optimum window for self-injecting.

At step S14, the output mechanism 14 outputs information to the second users regarding the adherence result. In this embodiment, the output mechanism 14 sends information to the web portal 12a via a network (not shown), where it can then be displayed to the second users.

In this embodiment, the second users view the information regarding the adherence result via the web portal 12a and can write messages to the first user to support adherence to the therapeutic regime. In this embodiment, the second users can use the web portal 12a to write the messages.

At step S15, the receiver mechanism 15 receives messages from the second users to the first user relating to the adherence result. For example, if the adherence result indicates that the first user correctly performed the therapeutic activity, then the messages from the second users could be congratulatory in nature, encouraging the first user to continue adhering to the therapeutic regime.

If the adherence result indicates that the first user incorrectly performed the therapeutic activity by self-injecting too early, then the messages from the second users could encourage the first user to self-inject within the therapeutic time window the next time (i.e. in another 13-15 days).

If the adherence result indicates that the first user incorrectly performed the therapeutic activity by missing the optimum window for self-injecting, then the messages from the second users could encourage the first user to self-inject as soon as possible—hence acting as a further reminder to the first user to carry out the therapeutic activity.

If the adherence result indicates that the first user incorrectly performed the therapeutic activity late by self-injecting after the optimum window for self-injecting, then the messages from the second users could encourage the first user to self-inject on time next time.

It will be appreciated that such messages, for example from a second user with the same health condition who suffered an onset event as a consequence of not adhering to the same therapeutic regime could be a very influential on the first user.

At step S16, the ranking processor 16 is arranged to assign a ranking score to each of the second users, with the ranking score relating to the likely influence between a said second user and the first user. In this embodiment, the ranking score relates to the likely influence of the said second user on the adherence of the first user to the therapeutic regime.

As discussed, the second users are selected by the system 10 to include those other users who are friends and family of the first user, those other users who have Crohn's disease, and those other users who need to self-inject as part of a therapeutic regime. It will be appreciated that for a large number of users stored in the user datastore 12, the number of second users sending messages to the first user may be large. This presents a problem that the user will be sent a large number messages, which in conventional messaging systems would be just displayed by such systems in a list (e.g. in date order).

In this embodiment, the ranking processor 16 uses both the relationship between the second users and the first user (inter-relational ranking) and the context of the messages (contextual ranking) to rank the second users. Hence, the ranking by the ranking processor 16 is used to rank the messages received from the second users, which enables the most relevant messages to be displayed more prominently to the first user.

In this example, those second users who are friends and family of the first user will receive a high interrelational ranking, as they have a close relationship to the user. Those second users who the first user does not have a previous relationship with will have a low inter-relational ranking. In the absence of other factors, messages from friends and family of the first user can be assumed to have a higher impact on the behavior of the first user than messages from strangers.

In this example, the contextual ranking will depend on the adherence result. For example, if the adherence result indicates that the first user correctly performed the therapeutic activity by self-injecting in the time window, then the messages from the second users are likely to be congratulatory in nature, and in this context, messages from friends and family of the first user are likely to be most effective as messages of support—because the congratulations will be coming from a friend or family member.

However, if the adherence result indicates that the first user incorrectly performed the therapeutic activity by self-injecting either too early or by missing the time window, then a message from a second user with the same health condition who has firsthand experience of non-adherence may be very effective as a message of support and encouragement. This is because, in this context, the message from such a second user with knowledge of the health condition could have higher impact on the behavior of the first user than a messages from someone (even if a familiar member) with no knowledge of the health condition.

As a result, the ranking processor 16 can rank the second users according to how effective their messages are likely to be on promoting adherence to the therapeutic regime of the first user. The balance between interrelational ranking and contextual ranking (and other potential ranking factors discussed below) will depend on the embodiment and the specific health condition and therapeutic activity.

In this embodiment, the user datastore 12 is arranged to store information on the relationships between the plurality of second users and the first user, and the ranking processor 16 is further arranged to assign higher ranking scores to those second users with closer relationships to the first user. For example, the “closeness” of the relationship may be determined according to: similarities in health conditions, whether a second user is a family member, friend, or acquaintance. This information may be obtained using a survey. In this embodiment, the user datastore 12 is arranged to store information on health conditions of the second users, and the ranking processor 16 is arranged to assign higher ranking scores to those second users with similar health conditions to the health condition of the first user.

Furthermore, the user datastore 12 is arranged to store information on therapeutic activities carried out by the second users, and the ranking processor 16 is arranged to assign higher ranking scores to those second users who carry out similar therapeutic activities to the therapeutic activity of the first user. In this embodiment, the ranking processor 16 is arranged to assign different ranking scores to the second users depending on the nature of the adherence result. The nature of the adherence result may be indicative of how well the first user performed the therapeutic activity. There may be many possibilities of how the nature of adherence result is influential on the assignment of ranking scores for the second users.

Hence, a message from a friend with the same health condition who needs to carry out the same therapeutic activity (and thus who would have interrelational ranking and high contextual ranking) would be ranked higher than a message from a second user unknown to the first user with an unrelated health condition.

At step S17, the output mechanism 14 outputs one or more messages from the second users to the first user in consideration of the ranking scores. In this embodiment, the output mechanism 14 outputs received messages from the second users to the first user, giving priority to messages from those second users who are ranked highly.

In this embodiment, the output mechanism 14 is arranged to display the messages to the first user on a display. Instead of displaying a list of messages in, for example, time/date order (as in conventional systems), in this embodiment the output mechanism 14 is arranged to display a list of received messages from second users, with the messages from the highest ranked second users displayed at the top of the list and in a larger font. As a result of this, the received messages from the highest ranked second users will be displayed the most prominently.

It will be appreciated that the receiver mechanism 15 could receive a large number of messages from second users. In a conventional system in which messages are displayed in time/date order, then the first user will be provided with a long list of messages, some of which will be more relevant than others. By ranking the second users in this way, the received messages from the most relevant second users (i.e. the highest ranked) will be displayed the most prominently. This maximizes the effect of the received messages and helps ensure that the first user reads the most important messages.

Hence, an important benefit of the system 10 as described above is that messages from the more relevant second users will be output in a more preferential way (e.g. at the top of the list and/or in a bigger font) than messages from less relevant second users.

In this embodiment, the output mechanism 14 outputs one or more messages from the second users to the first user in consideration of the ranking scores as the messages from the second users are received. However, as discussed in more detail later, the delivery of the messages can be scheduled to optimize the effectiveness of the message. For example, the time of delivery of message to the first user can be scheduled according to message contents and previous or historical sequence of adherence event(s).

In some embodiments, the output mechanism comprises a number of devices capable of outputting the messages to the first user. In such embodiments, the ranking processor can be arranged to determine which of these devices to use to output each message to the first user based on the therapeutic activity to which each message relates to. Hence, in such embodiments, the delivery mechanism for the messages can be determined based on the ranking of the second users to optimize the effectiveness of the messages. This provides another way in which received messages from the most relevant second users (i.e. the highest ranked) can be displayed the most prominently (e.g. on the most prominent/noticeable output device).

The ranking of the second users can be done in a number of ways, with the balance between different ranking factors discussed depending on the embodiment and the specific health condition and therapeutic activity.

In some embodiments, the user datastore 12 is arranged to store information on the location proximity between the plurality of second users and the first user, and the ranking processor 16 is arranged to assign higher ranking scores to those second users who live closest to the first user. In this embodiment, the location proximity between the plurality of second users and the first user may be measured in terms of the distance between the first user and a second user.

In some embodiments, the user datastore 12 is arranged to store information on the frequency of contact between the each of the second users and the first user, and the ranking processor 16 is arranged to assign higher ranking scores to those second users with more frequent contact with the first user.

The frequency of contact between the each of the second users and the first user could be determined by interactions (e.g. messages sent/received) via the web portal 12a.

The frequency of contact between the each of the second users and the first user could be determined in other ways, such as whether the first user viewed a profile of the second user stored on the web portal 12a. In some examples, the web portal 12a could have a message board facility, and the frequency of contact between the each of the second users and the first user could be determined whether the first user liked (or otherwise up-rated) messages from the second user on the message board of the web portal 12a. The frequency of contact between the each of the second users and the first user could be determined by analyzing other communication (including liking or otherwise up-rating messages) on social networks.

In some embodiments, the user datastore 12 is arranged to store information on the frequency of physical contact between the each of the second users and the first user, and the ranking processor 16 is arranged to assign higher ranking scores to those second users with more frequent physical contact with the first user. The frequency of physical contact between the each of the second users and the first user could be determined in a number of ways, for example by analyzing message histories or social media interaction.

In some embodiments, the monitor mechanism 13 is arranged to determine how long the first user spends viewing messages from each of the second users, and this information is stored in the user datastore 12. In such embodiments, the ranking processor 16 can be arranged to assign higher ranking scores to those second users whose messages are viewed for longer by the first user. In this embodiment, the assignment of ranking scores is performed subsequent to the initial output of messages from second users. For example, as discussed, the web portal 12a could have a message board facility, and the monitor mechanism 13 is arranged to determine how long the first user spends viewing messages made by each of the second users on the message board facility.

In some embodiments, the system 10 can further comprise a user input arranged to receive an input from the user indicating how useful the first user found each message from the second users in aiding adherence to the therapeutic regime. In such embodiments, this input can be used in the determining of the ranking scores. Second users whose messages have been considered to be useful in the past could be ranked higher.

In some embodiments, the ranking processor 16 is arranged to assign different ranking scores to the second users depending on the content of the messages sent by the second users. In other words, the ranking processor 16 can analyze the content of the messages received from the second users (e.g. by determining if the messages contain certain keywords) and can assign higher rankings to messages that are considered to be more relevant. For example, a message from a family member including the term “injection” is likely to be very relevant to the first user who needs to perform self-injection in the above example.

In some embodiments, the second users can send messages directly to the device of the first user, for example, not via a web portal but via an alternative messaging system such as email, SMS or other such messaging system. In some embodiments, the ranking processor can use the communications method used by the second users to send messages to the first user in the ranking.

For example, consider a situation in which the first user has indicated a preference for using a video chat service, for example because the first user likes video chatting with other users about their health condition. In such a situation, if a second user sends a message to the first user via a messaging system associated with the video chat service preferred by the first user, then that second user could be ranked higher than they otherwise would be.

In this some embodiments, if no messages are received from any second users, the output mechanism 14 is arranged to output a message prompt to second users to send messages.

In some embodiments, the ranking processor 16 is arranged to compare the ranking scores of those second users for which messages are received with a stored threshold. If the ranking scores of those second users for which messages are received are below the stored threshold, the output mechanism 14 is arranged to output a message prompt to second users whose ranking scores are above the stored threshold. Hence, in such embodiments, the system can issue prompts to ensure that highly ranked second users send messages of support to the first user.

In some embodiments of the invention, a patient (i.e. the first user) consents to sharing aspects of a care plan (i.e. a therapeutic regime) with third parties (i.e. second users). The second users can be sign up through the web portal 12a to receive updates for first user. The second users then receive a copy of aspects of care plan. Medication adherence events (i.e. therapeutic activities) are identified and posted together on the web portal 12a with regular updates on medication adherence. Then the likely influence of second users to the first user is determined The second users then contribute messages of support to the first user. If influential second users are initially unavailable, then they could be prompted to leave a message. Messages received from second users are then ranked according to (i) the overall influence of the second user and (ii) the contextual influence of the message. The delivery of the messages is then scheduled, and the time of delivery of message to the first user is scheduled according to message contents and previous or historical sequence of adherence event(s). Until the scheduled time of delivery, the system can collect more message during time window when messages can be delivered. The selected messages are communicated over time through the output means 14. In embodiment, in which the output means comprises a number of devices, then the communication device which—at the time the message is communicated—has most contextual influence with the patient is chosen for delivery of the message.

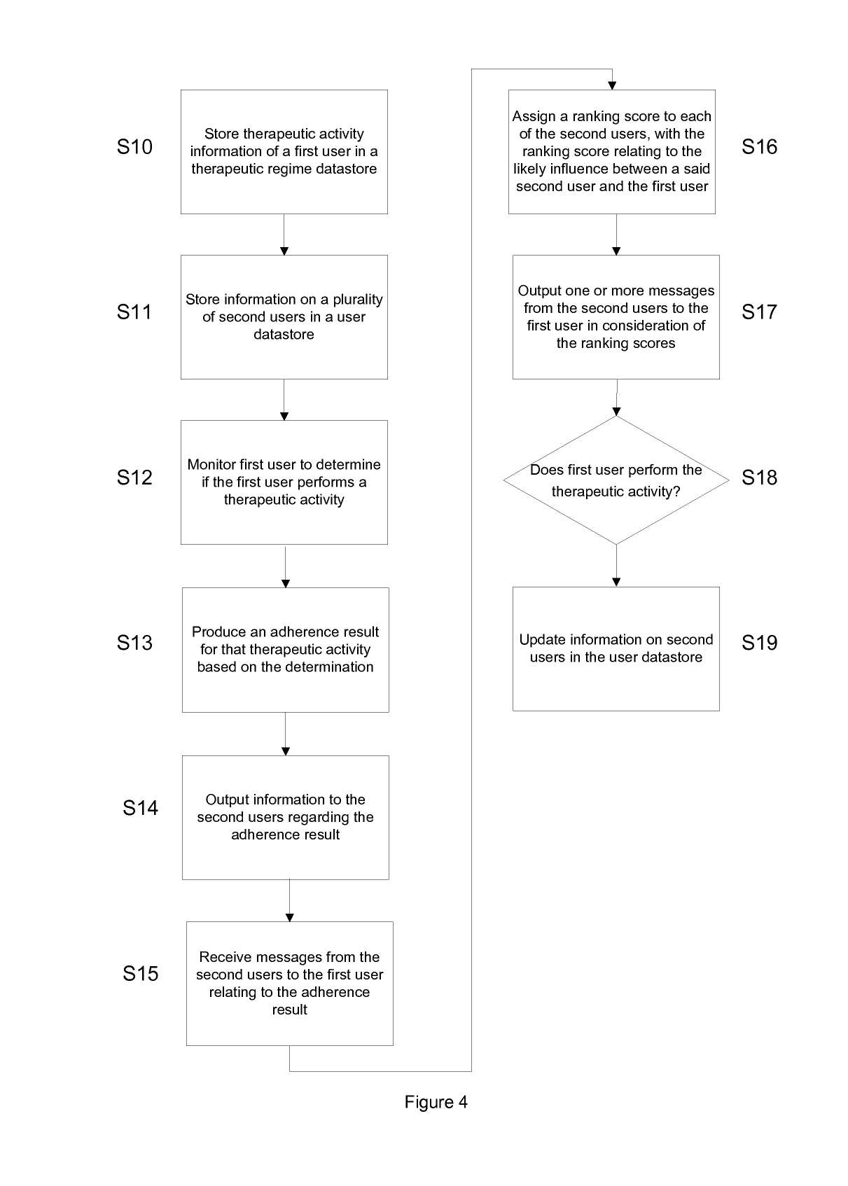

FIG. 4 shows a flow diagram explaining the operation of the system 10 in another embodiment of the invention. As for FIG. 3, this embodiment will be explained by way of an example in which the first user Crohn's disease, and who must self-inject biologics at intervals of 13-15 days.

In this embodiment, the monitor mechanism 13 is arranged to determine if the therapeutic activity is subsequently performed by the first user following the output of a message from one of the second users to the first user. Following this, the user datastore 12 is arranged to store information on which second users' messages are effective in causing the therapeutic activity to be performed following the output of the messages. The ranking processor 16 can then use this information to assign higher ranking scores to those second users whose messages are effective in causing the therapeutic activity to be performed following the output of the messages. In this embodiment, the assignment of high ranking scores to those second users whose messages are effective is performed subsequent on the initial output of the messages.

Steps S10 to S17 of FIG. 4 are the same as for FIG. 3. As a result, in step S17, the output mechanism 14 outputs one or more messages from the second users to the first user in consideration of the ranking scores.

At step S18, the monitor mechanism 13 determines if the first user performed the therapeutic activity following the output of the messages from the second users. In this example, the monitor mechanism 13 receives a user indication from the first user when the user has self-injected the biologics, for example via a suitable user interface.

At step S19, the user datastore 12 is updated by the system to store information on which second users' messages are effective in causing the therapeutic activity to be performed following the output of the messages. A message from a second user whose previous message was effective in causing the first user to carry out the therapeutic activity is likely to be effective.

In some embodiments, the system can check to see if the user reads the second users' messages, and can update the rankings following the first user carrying out the therapeutic activity only for those second user's whose messages were read.

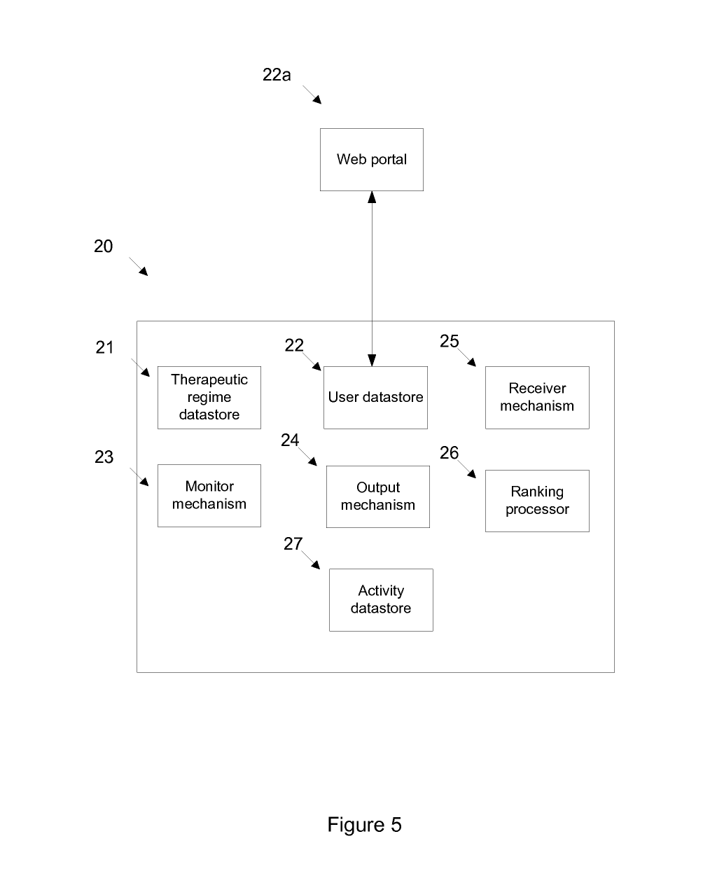

FIG. 5 schematically shows a system 20 for messaging a user according to a third embodiment of the invention. In this embodiment the system could be used by a first user with a long term health condition, with the first user having a therapeutic regime comprising a number of therapeutic activities that the user should perform to adhere to the therapeutic regime.

The system 20 comprises a therapeutic regime datastore 21, a user datastore 22, a monitor mechanism 23, an output mechanism 24, a receiver mechanism 25, a ranking processor 26, and a non-therapeutic activity datastore 27. In this embodiment, the user datastore 22 is associated with a web portal 22a that can display information to second users.

The therapeutic regime datastore 21 is arranged to store therapeutic activity information including information on therapeutic activities forming part of the therapeutic regime of the first user. In this embodiment, the therapeutic regime datastore 21 is part of the memory or other storage unit of the smart phone, and the therapeutic activity information including information on therapeutic activities forming part of the therapeutic regime of the first user could be received via the web portal 22a.

The user datastore 22 is arranged to store information on a plurality of second users. The second users in this embodiment include other users who may wish to send messages (e.g. messages of support or encouragement) to the first user regarding the first user's therapeutic regime. In this embodiment, the user datastore 22 is associated with a web portal 22a that can display information to second users.

The monitor mechanism 23 is arranged to monitor the first user to determine if the first user performs a therapeutic activity for which therapeutic activity information is stored in the therapeutic regime datastore 21. The monitor mechanism 23 is also arranged to produce an adherence result for that therapeutic activity based on the determination.

The output mechanism 24 is arranged to output information to the second users regarding the adherence result. In this embodiment, the output mechanism 24 is arranged to output the information to the second users regarding the adherence result using the web portal 22a via a suitable network (not shown), so that the second users can view the information regarding the adherence result via the web portal 22a. The output mechanism 24 is also arranged to output messages received from the second user to the first user. In this embodiment, the output mechanism 24 is arranged to output the messages to the first user using a display.

The receiver mechanism 25 is arranged to receive messages from the second users to the first user relating to the adherence result.

The ranking processor 26 is arranged to assign a ranking score to each of the second users, with the ranking score relating to the likely influence between the second users and the first user. In this embodiment, the ranking score relates to the likely influence of the said second user on the adherence of the first user to the therapeutic regime.

The non-therapeutic activity datastore 27 is arranged to store information regarding non-therapeutic activities that could be carried out by the first user. As described in more detail below, the non-therapeutic activity information is used by the monitor mechanism 23 to monitor the user, so as to enable messages from the second users to be delivered at an optimum time, e.g. by delivering a message when the user is carryout out (or not carrying out) certain non-therapeutic activities. The non-therapeutic activity information can be set by the user or by a third party.

The term “non-therapeutic activity” is used herein in the broad sense, to encompass any activity that the user may be engaged in or any state of the user. The non-therapeutic activity could relate to an action of the user (e.g. watching television) or a passive activity (e.g. being at a certain location).

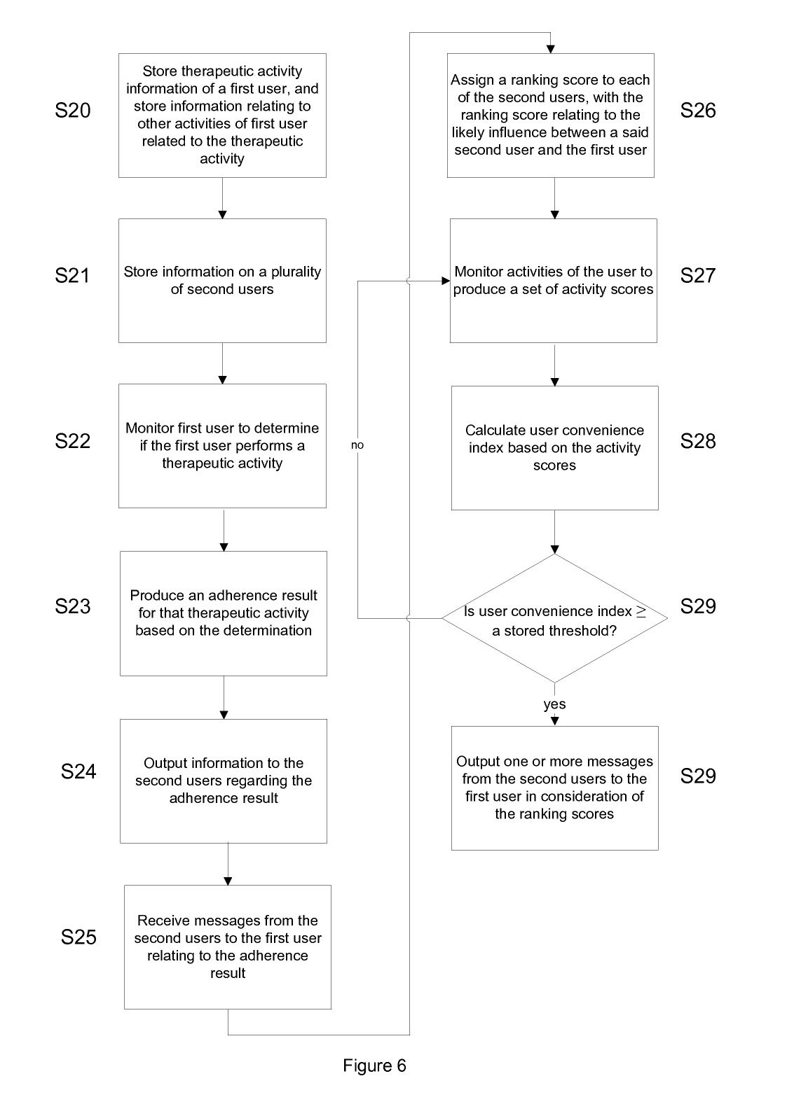

FIG. 6 shows a flow diagram explaining the operation of the system 20. In this explanation, as an example, a first user with Chronic obstructive pulmonary disease (COPD) disease will be considered.

Chronic obstructive pulmonary disease (COPD) is the occurrence of chronic bronchitis or emphysema, a pair of commonly co-existing diseases of the lungs in which the airways become narrowed. This leads to a limitation of the flow of air to and from the lungs, negatively impacting gas exchange and causing shortness of breath (dyspnoea).

For COPD the daily oral medication is complemented by daily inhalation medication (long-acting bronchodilators with steroids), symptom based inhalation medication (short acting bronchodilators) used in case of shortness of breath and for severe cases with oxygen therapy and non-invasive ventilation.

Not taking bronchodilators leads to shortness of breath and higher sensitivity of the lung tissues to infections and external stimuli, leading further to COPD acute exacerbation, requiring an emergency room visit. Roughly 30% of those emergency room visit result in the hospitalization of the patient, with roughly 10% of those hospitalizations being mortal.

Not using oxygen therapy leads to hypoxemia or hypercapnia, which could cause loss of consciousness, irreversible damage of brain cells or respiratory failure. The latter always requiring hospitalization and highly mortal, the former two very dangerous and having long term irreversible effect on quality of life.

In step S20 of FIG. 6, the system 20 stores therapeutic activity information of the first user. In this embodiment, the system 20 determines the therapeutic activity information using data from a healthcare professional, for example via a suitable network.

In step S20 of FIG. 6, the system 20 also stores a selection of user activities to monitor the user as non-therapeutic activity information in the non-therapeutic activity datastore 27. The non-therapeutic activity information comprises a selection of activities that could be carried out by the user that are considered likely to have an effect on the efficacy of a message sent by a second user. As discussed below, monitoring the non-therapeutic activities of the user is very useful when considering when to output messages to the first user. For example, a message from the second user is intended to be a prompt to carry out a therapeutic activity (i.e. act as a reminder), then delivering the message at an optimum time will maximize the effectiveness of the message.

For example, if the therapeutic activity associated with the message from a second user is a message aimed to encourage the first user to perform their oxygen therapy (e.g. after a missed therapeutic activity), then the efficacy of the message from the second user associated with that therapeutic activity may be increased if the message is delivered when the user is relaxed and at home. In contrast, the efficacy of the message associated with that therapeutic activity may be decreased if the message is delivered when the user is doing a non-interruptible task such as making a telephone call.

In this embodiment, the system 30 determines the non-therapeutic activity information using a user input. In other words, the user enters a set of non-therapeutic activities that are relevant to how likely they are to perform the therapeutic activity, along with an indication whether the non-therapeutic activity is considered to be likely to have a positive or negative effect on how likely there are to perform the therapeutic activity.

Steps S21 to S26 are equivalent to steps S11 to S16 of FIG. 3, and will not be described in detail.

At step S27, the monitor mechanism 23 of system 20 monitors the user using the non-therapeutic activity information. In other words, the monitor mechanism 23 monitors whether the user is carrying out the non-therapeutic activities included in the non-therapeutic activity information. In this embodiment, the monitor mechanism 23 determines if each activity in the non-therapeutic activity information is being carried out, and then assigns a set of activity scores.

A step S28, the monitor mechanism 23 calculates a user convenience index using the activity scores. In this embodiment, the user convenience index is a monitoring result that is a sum of the activity scores. In other embodiments, the monitor mechanism 23 can determine the monitoring result in other ways.

Then, at step S29, the ranking processor 26 calculates whether the user convenience index is greater than or equal to a threshold. If the user convenience index is greater than or equal to the threshold, then, at step S29, the output mechanism 24 outputs one or more messages from the second users to the first user in consideration of the ranking scores. If the user convenience index is not above the threshold, then the monitoring of the activities the user using the activity information continues (step S27).

In this embodiment, the messages from the second users are displayed on the system 20 via the output mechanism 24 comprising a display. In other embodiments, the messages may be communicated in any of a variety of ways including audible, visual or tactile signals to a smart phone, nearby display, and the user of a wearable device.

To help explain steps S27, S28 and S29, an example scenario will be discussed in relation to the first user with Chronic obstructive pulmonary disease (COPD) disease. In this example, the first user has a smart phone acting as the device of the system 20. As discussed, COPD is associated with a number of therapeutic activities, and in this example oxygen therapy will be considered.

In this example, in step S20, the user is then presented with a list of non-therapeutic activities by the smart phone that can be monitored and that are relevant to the likelihood of the user performing the therapeutic activity. The user can then select those non-therapeutic activities from the list, and indicate whether those activities are likely to have a positive or negative impact on the likelihood of the user performing the therapeutic activity. In other embodiments, the system can determine which non-therapeutic activities are likely to have a positive or negative impact on the efficacy of the likelihood of the user performing the therapeutic activity automatically, for example by consulting a look-up table. Furthermore, such a look-up table could be dynamically updated taking into account how effective messages of support are at causing the therapeutic activity to be performed while the user is carrying out certain non-therapeutic activities.

In other embodiments, the relevance of the non-therapeutic activities can be determined based on whether those activities are likely to have a positive or negative impact on the efficacy of the message of support. For example, regardless of whether the message is a prompt to perform a therapeutic activity or not, there will still be relatively good and relatively bad times to deliver messages to the user based on what non-therapeutic activities the user is doing.

In some embodiments, the user may pick from a large selection of possible non-therapeutic activities. In other embodiments, the system may select appropriate non-therapeutic activities without a user input, for example based on a pre-stored set of criteria.

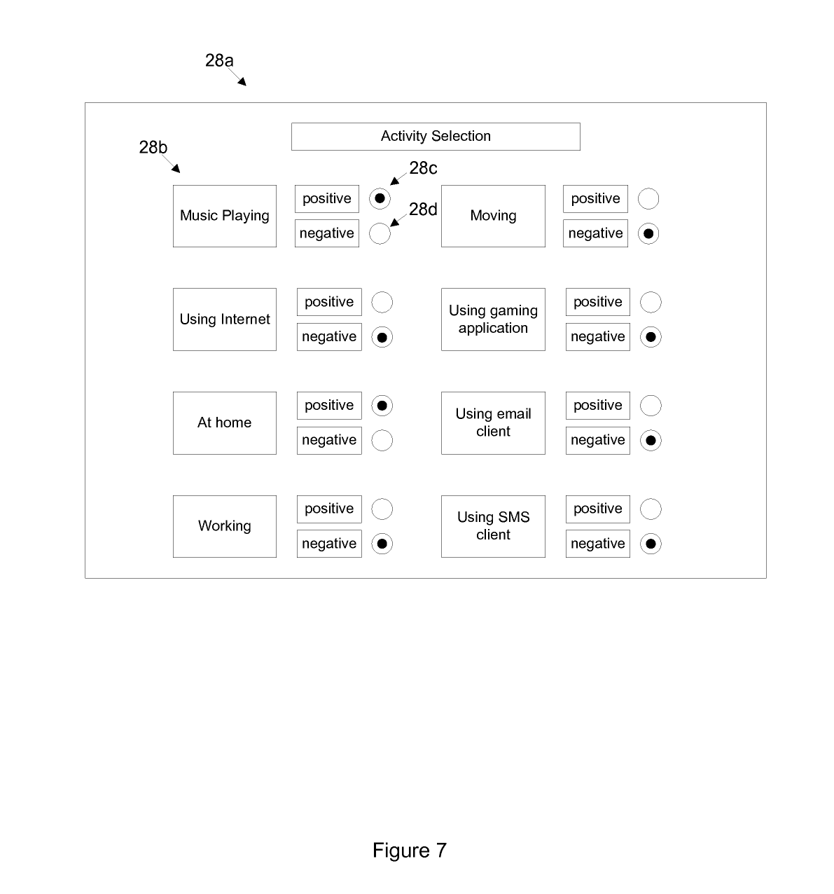

For example, the user could be presented with the non-therapeutic activities shown in FIG. 7. FIG. 7 shows an example user interface 28a for enabling the user to indicate which of a set of activities are considered likely to have a positive or negative impact on the likelihood of the user performing the therapeutic activity. In this embodiment, the user interface 28a would be displayed on the display of the system 20.

As shown in FIG. 7, the interface 28a shows a number of activities 28b, along with check boxes 28c and 28d that the user can user to indicate if they consider that these activities have a positive or negative effect on the likelihood of the user performing the therapeutic activity following a message from a second user. In this embodiment, not ticking a check box for an activity indicates that the user considers that activity has a neutral effect on the likelihood of the user performing the therapeutic activity.

If a non-therapeutic activity is considered to have a positive effect on the likelihood of the user performing the therapeutic activity, then the message from the second user (e.g. encouraging the first user to carry out the therapeutic activity) is likely to be more efficacious if that activity is being carried out when a message from the second user is output. If the non-therapeutic activity is considered to have a negative effect on likelihood of the user performing the therapeutic activity, then the message is likely to be less efficacious if that activity is being carried out when the message is output.

Each of these non-therapeutic activities would be monitored by the monitor mechanism 23 in an appropriate way for each activity. The activities in FIG. 3 are:
Music Playing: This indicates whether the system 20 is playing music. In this example, the user has indicated that this has a positive impact on the likelihood of the user performing the therapeutic activity (i.e. oxygen therapy in this example). This may be because, for example, the first user in general prefers to listen to music while performing the oxygen therapy. This activity could be monitored by the monitor mechanism 23 by determining if a music function of the system 20 is activated.
Using Internet: This indicates whether the system 20 is accessing the Internet. In this example, the user has indicated that this has a negative impact on the likelihood of the user performing the therapeutic activity. This may be because, for example, the first user prefers not to be distracted when using the Internet. This activity could be monitored by the monitor mechanism 23 by determining if a web browser function of the system 20 is activated.
At home: This indicates whether the system 20 is at the designated home location of the user. In this example, the first user has indicated that this has a positive impact on the likelihood of the user performing the therapeutic activity. This may be because, for example, the user prefers to carry out oxygen therapy while at home or because this is where the appropriate equipment is located. This activity could be monitored by the monitor mechanism 23 by using a GPS function of the system 20, or another suitable location function.
Working: This indicates whether the first user is working, for example using a work related application on the system 20. In this example, the first user has indicated that this has a negative impact on the likelihood of the user performing the therapeutic activity. This may be because, for example, the user prefers to carry out oxygen therapy while not working. This activity could be monitored by the monitor mechanism 23 by determining if the work related application on the system 20 is activated.
Moving: This indicates whether the system 20 is moving. In this example, the first user has indicated that this has a negative impact on the likelihood of the user performing the therapeutic activity. This may be because, for example, the user prefers to carry out oxygen therapy while seated. This activity could be monitored by the monitor mechanism 23 by using an accelerometer function of the system 20.
Using gaming application: This indicates whether the first user is using a gaming application. In this example, the first user has indicated that this has a negative impact on the likelihood of the user performing the therapeutic activity. This may be because, for example, the user prefers not to be interrupted with playing games. This activity could be monitored by the monitor mechanism 23 by determining if a gaming application on the system 20 is activated. Using email client: This indicates whether the user of system 20 is using an email client on the system 20. In this example, the user has indicated that this has a negative impact on the likelihood of the user performing the therapeutic activity. This may be because, for example, the user prefers not to be interrupted with sending or reading emails. This activity could be monitored by the monitor mechanism 23 by determining if the email client on the system 20 is activated.
Using SMS client: This indicates whether the user of system 20 is using an SMS client on the system 20. In this example, the user has indicated that this has a negative impact on the likelihood of the user performing the therapeutic activity. This may be because, for example, the user prefers not to be interrupted with sending or reading SMS messages. This activity could be monitored by the monitor mechanism 23 by determining if the email client on the system 20 is activated.

Furthermore, in this embodiment, there are other non-therapeutic activities that have pre-stored influences on likelihood of the user performing the therapeutic activity, without requiring a user input. For example, the system 20 is arranged to store that making a telephone call using the system 20 has a negative impact on the likelihood of the user performing all therapeutic activities. Hence, for the non-therapeutic activity of “making a call” it is not necessary to present the user with an option for choosing whether the activity has a positive or negative impact, as it is always considered to have a negative impact. Such non-therapeutic activities could always be present in the non-therapeutic activity information, regardless of whether the user is given a choice of which other activities comprise the activity information.

Hence, at step S20, the user's preferences for each selected activity, along with any non-therapeutic activities whose influences on efficacy is predefined, are stored as non-therapeutic activity information in the non-therapeutic activity datastore 27.

At step 27, the monitor mechanism 23 monitors each of the selected activities, and at step S28 a user convenience index is calculated based on the monitoring. The user convenience index is calculated by considering the sum of the positive and negative influences on the likelihood of the user performing the therapeutic activity.

In this embodiment, an activity score is determined for each non-therapeutic activity, with the user convenience index being a sum of the activity scores. In this embodiment, if an activity whose influence is positive is being performed, then an activity score of 1 is given. If a non-therapeutic activity whose influence is negative is being performed, then an activity score of −1 is given. If the activity is not being performed (regardless of whether positive or negative), or if the user indicated that the activity had a neutral influence (e.g. by not ticking either the positive or negative check box in FIG. 7), then an activity score of 0 is given.

To help illustrate this example, three example states of the user will now be discussed with references to Table 1.

In state 1, the user is listening to music, using the internet, while walking in the park. The user is therefore not at home, and is moving. The user is not working, and not using a gaming application, email client or SMS client.

In state 2, the user is at home sitting down (and thus not moving), while making a call; while not using the internet, not listening to music, and not using a gaming application, email client or SMS client.

In state 3, the user is at home sitting down (and thus not moving), using the internet; while not listening to music, not working, and not using a gaming application, email client or SMS client.

The activity scores and user convenience index associated with states 1, 2 and 3 are shown in Table 1.

TABLE 1

| | Score in | Score in | Score in |
|---|---|---|---|
| Activity | State 1 | State 2 | State 3 |
| Music Playing | 1 | 0 | 0 |
| Using Internet | −1 | 0 | −1 |
| At home | 0 | 1 | 1 |
| Working | 0 | 0 | 0 |
| Moving | −1 | 0 | 0 |
| Using gaming application | 0 | 0 | 0 |
| Using email client | 0 | 0 | 0 |
| Using SMS client | 0 | 0 | 0 |
| Making a call | 0 | −1 | 0 |
| User convenience index | −2 | 1 | 0 |

At step S29, the system determines whether the user convenience index is greater than or equal to the stored threshold. In this example, the stored threshold is 1. Hence, for states 1 and 3, the user convenience index is determined to be less than the stored threshold. Therefore, for states 1 and 3, the system continues to monitor the user (step S27).

For state 2, the user convenience index is determined to be equal to the stored threshold. Hence, the system progresses to step S29, and the reminder is output to the user to pay the utility bill.

Hence, in this embodiment, the user is presented with a message about a therapeutic activity at a time that is considered to be appropriate for that therapeutic activity. This is done by delivering the message when the first user is carryout out (or not carrying out) certain non-therapeutic activities that are considered to have a positive or negative effect on the likelihood of the first user carrying out the therapeutic activity.

This enables such embodiments of the invention to provide much more effective messages when compared to conventional systems that simply provide messages or reminders at an absolute time.

The messaging system according to this embodiment can be used to ensure that the message (e.g. acting as a reminder for a missed therapeutic activity) is delivered when the first user is likely to be receptive to the message. Moreover, the first user may establish a more positive association with the therapeutic activity of which he/she is reminded/messaged because the message does not come at an inconvenient moment which may be perceived as annoying, but rather at a moment that he/she can act upon it.

In the above example, the therapeutic activity (i.e. oxygen therapy) is not associated with a time period for carrying out the therapeutic activity. However, it will be appreciated that other therapeutic activities can be associated with a predetermined time window.

In the above example, in step S20, the user is presented with a list of non-therapeutic activities by the smart phone that can be monitored and that are relevant to the likelihood of the user performing the therapeutic activity. In other embodiments, the relevance of the non-therapeutic activities can be determined based on whether those activities are likely to have a positive or negative impact on the efficacy of the message of support. For example, regardless of whether the message is a prompt to perform a therapeutic activity or not, there will still be relatively good and relatively bad times to deliver messages to the user based on what non-therapeutic activities the user is doing.

As discussed above, in some embodiments, the system can comprise an activity datastore arranged to store non-therapeutic activity information comprising information on non-therapeutic activities that are considered to have an effect on the impact of the message. In some embodiments, the impact of the message relates to the likelihood of the first user performing the therapeutic activity.

In such embodiments, the monitor mechanism is arranged to monitor the user to determine if the user is performing one or more non-therapeutic activities for which non-therapeutic activity information is stored in the activity datastore and to produce a monitoring result based on the determination. The ranking processor is arranged to determine when to send the first user the one or more messages from the second users based on the monitoring result, and the ranking processor is arranged to compare the monitoring result to a stored parameter. The output mechanism is arranged to time the output the one or more messages from the second users to the first user on the basis of the comparison of the monitoring result and the stored parameter.

In some embodiments, the stored parameter is a threshold, and the output mechanism is arranged to output the one or more messages from the second users to the first user when the monitoring result meets or exceeds the threshold.

In some embodiments, the monitor mechanism is arranged to monitor each non-therapeutic activity in the non-therapeutic activity information, and to assign an activity score based on whether that activity is being performed.

In this embodiment the threshold for the monitoring result (e.g. user convenience index) is fixed. However, in other embodiments, the threshold may vary, either with time or as a result of another adjustment by the system 20. For example, in embodiments in which the therapeutic activity is associated with a predetermined time window, the threshold may be lowered towards the end of the predetermined time window, thus helping to ensure that the message is provided within the predetermined time window.

In other embodiments, the threshold may be varied by the system for other reasons. For example, the system 20 may monitor compliance with a message acting as a reminder (i.e. whether the message as a reminder was acted upon or ignored) and use this to vary the threshold.

In the above mentioned example, the possible activity scores for each activity are −1, 0 and 1, representing a simple positive, neutral (or activity not being performed) or negative effect on the efficacy of the reminder, with the monitoring result being the sum of the activity scores. However, in other embodiments, different activities can be associated with different weights, with the weights either being predetermined or set by the user. Hence, in such embodiments, when the user convenience index is calculated, it will take into account the differently weighted activity scores. Hence, in some embodiments, the monitor mechanism 23 is arranged to assign different weight values to different activities scores.

In some embodiments, the system 20 is arranged to determine if the therapeutic activity is performed following the output of the messages. For example, the system 20 may be able to monitor (e.g. using the monitor mechanism 23 or other monitoring equipment) that the therapeutic activity has been performed. The system 20 could also rely on a user input to determine if the therapeutic activity has been performed following the message.

In some embodiments, the system 20 may determine that the therapeutic activity for which the message relates has actually been performed before the reminder has been issued. In such scenarios, the system 20 may opt to not present the message to the user.

In embodiments in which the system 20 obtains information (either via a user input or by monitoring) that the therapeutic activity has been completed, the system 20 can store adherence information relating to the non-therapeutic activity activities being performed by the user at the time of the therapeutic activity being completed. For example, the system 20 could analyze what activities (whether they are the ones stored in S20 or other activities monitored by the system 20) the user was carrying out while the therapeutic activity was performed, and use this information to improve the outputs of the messages in an iterative way. For example, the system 20 could use the adherence information to adjust the weights of the activity scores, to add activities into the set of activities used to calculate the monitoring result (e.g. user convenience index), and/or to vary the threshold.

This is useful in many circumstances. For example, even though such embodiments of the invention provide messages that are more likely to be acted upon than conventional systems, it is still possible that the message will be ignored. By using the adherence information in this way, the system of such embodiments can adapt to the precise demands of the user in order to improve the efficiency of the messaging system.

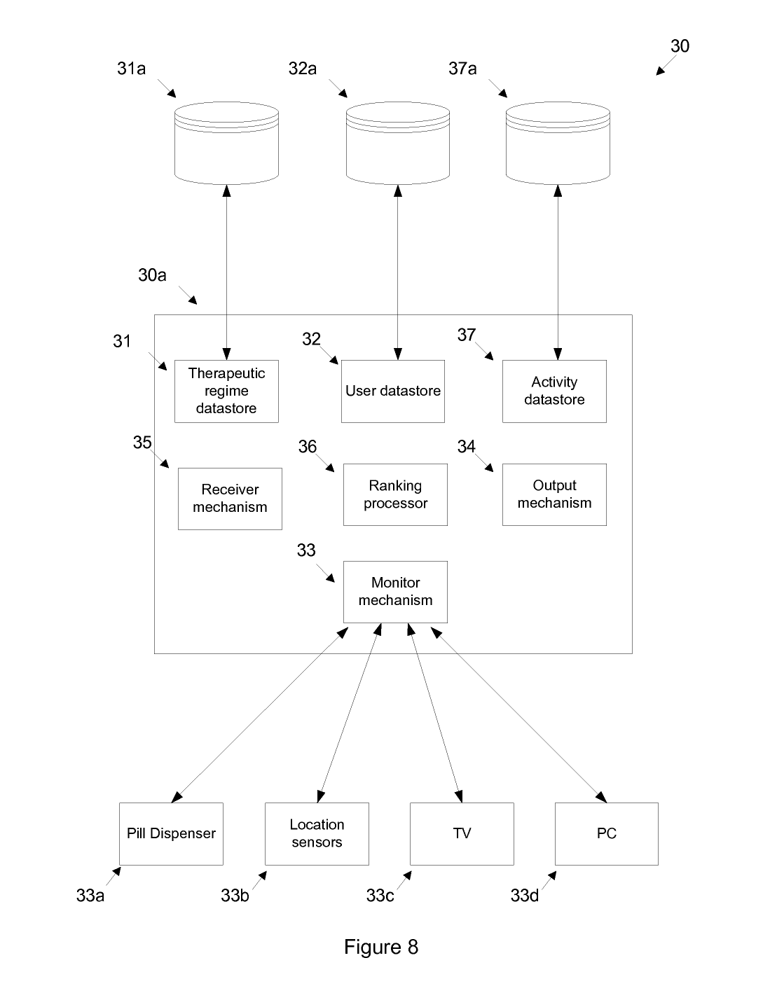

FIG. 8 schematically shows a system 30 for messaging a user according to a fourth embodiment of the invention. In this embodiment the system could be used by a first user with a long term health condition, with the first user having a therapeutic regime comprising a number of therapeutic activities that the user should perform to adhere to the therapeutic regime.

The system 30 comprises a device 30a and a number of remote devices, including a remote therapeutic regime datastore 31a, a remote user datastore 32a, a remote activity database 37a, and a number of remote monitor mechanisms 33a, 33b, 33c and 33d. The device 30a comprises a therapeutic regime datastore 31, a user datastore 32, a monitor mechanism 33, an output mechanism 34, a receiver mechanism 35, a ranking processor 36, and a non-therapeutic activity datastore 37.

The device 30a is in communication with the remote reminder database 31a, the remote user datastore 32a, the remote activity database 37a, and the remote monitor mechanisms 33a, 33b, 33c and 33d via suitable interfaces. For example, the device 30a could be connected to the remote therapeutic regime datastore 31a and the remote user datastore 32a via a network, such as the internet. The device 30a could be connected to the remote monitor mechanisms 33a, 33b, 33c and 33d via a short range wireless connection, such as Bluetooth. It will, however, be appreciated that other embodiments could use other ways of connecting the remote devices to the device 30a.

In this embodiment, the device 30a is a portable device (e.g. a smart phone) carried by the user. In other embodiments, the device 30a could be a standalone device that is not portable. In other embodiments, the device 30a could be integrated into the functionality of a general purpose device.

In this embodiment, the remote monitor mechanisms are a pill dispenser 33a, location sensors 33b, a TV 33c and a personal computer (PC) 33d.

In this embodiment, the pill dispenser 33a is near field communication (NFC) enabled and can detect if the user is near the pill dispenser 33a, e.g. within a range of 1 m. In this embodiment, the user wears a suitable NFC device (e.g. a suitable bracelet), which is used by the pill dispenser 33a to detect if the user is within range. In other embodiments, the pill dispenser 33a could detect whether the user is within range by other means.

The pill dispenser 33a can also, in this embodiment, detect if a pill has been dispensed, and only dispense pills at the correct time. In this embodiment, the pill dispenser 33a can provide information on whether the user is near the pill dispenser 33a and whether a pill has been dispensed to the monitor mechanism 33. It will be assumed in the discussion below, for ease of explanation, that the pill dispenser 33a is in the user's kitchen.

In addition, in this embodiment, the pill dispenser 33a can also provide audible and visual alerts, as well as display messages.

In this embodiment, the location sensors 33b are spaced apart in the user's house and can detect where in the house the user is, providing this information to the monitor mechanism 33.

In this embodiment, the TV 33c and the personal computer (PC) 33d can detect what actions the user is performing on them (e.g. whether a favored TV show is being watched on the TV 33c or whether the internet browser of the PC 33d is being used) and can provide this information to the monitor mechanism 33. It will be assumed in the discussion below, for ease of explanation, that the TV 33c and PC 33d are in the user's living room, where it is assumed that the user spends most of him time while at home.

In this embodiment, the output mechanism 34 is capable of providing an audible, vibrating and visual message on the device 30a. The output mechanism 34 is also capable of instructing the pill dispenser 33a to provide an audible and visual message. The output mechanism 34 can also interface with the TV 33c to enable the TV 23c to display a visual message.

An example operation of such an embodiment will now be described. In this example, it will be assumed that the therapeutic regime of the first user consists of a medication regime which requires the user to take a pill twice a day, with the intervals as spaced apart and as regular as possible. It will also be assumed the first user in this embodiment is patient who is generally sedentary, spending much of his time watching television or using the internet.

The system 30 obtains therapeutic activity information about a medication regime, the therapeutic activity information including a set of time windows for taking the medication. In this embodiment, this is done by the device 30a querying the remote therapeutic activity database 31a to obtain therapeutic activity information associated with the medication regime of the patient.

The information in the therapeutic regime database 31a could be obtained in a variety of different ways. For example it could be obtained by a health care professional uploading a care plan that includes data such as medication, exercise regime, and diet plan that the patient needs to adhere to. The therapeutic activity information could contain information associated with all aspects of this care plan. In other embodiments, a health care professional could scan a bar code relating to a medication (or enter a suitable reference number), which would load information on the medication including the schedule for taking it. In other embodiments, the details could be obtained by the remote reminder database 31a in other ways, for example by manual input.

In this embodiment the therapeutic activity information includes time windows for which the medication should be taken, as the task of taking the pill must be taken twice a day.

The system 30 then obtains information on a set of user activities used to monitor the user and stores this as non-therapeutic activity information. In this embodiment, this is done by the device 30a querying the remote activity database 37a to obtain details of which activities are the most important to efficacy of messages associated with the therapeutic activities in the therapeutic activity information. The non-therapeutic activity information could also take into account the capabilities of the system 30, e.g. relating to which activities the system 30 is capable of monitoring.

In this embodiment, the monitor mechanism 33 is connected to remote monitor mechanisms that include the NFC enabled pill dispenser 33a, location sensors 33b, the TV 33c and the personal computer (PC) 33d, which are relevant to the therapeutic activity (taking a pill) in this embodiment. Hence, the non-therapeutic activity information contains the activities associated with these remote monitors, along with whether these non-therapeutic activities have a weighted positive or negative likely effect on the efficacy impact of a message associated with the therapeutic activity.

In this embodiment, the monitor mechanism 33 is further able to determine if the user is making a telephone call, and this activity is included in the activity information.

The user datastore 32 is arranged to store information on a plurality of second users, and is in communication with a remote user datastore 32a that contains details of other users. In this embodiment, the remote user datastore 32a is associated with a web portal (not shown) via with the details of the other users are obtained. In other embodiment, the remote user datastore 32a could contain information about other users obtained via other means (e.g. via healthcare professionals).

Once the system 30 has obtained the information on a plurality of second users, the non-therapeutic activity information and the therapeutic activity information, the system 30 can begin monitoring the user. In this embodiment, the therapeutic activity information included in the therapeutic activity information is associated with time windows for performing the therapeutic activity.

In some embodiments, the time windows could be included in the therapeutic activity information and provided to the system 30, or could be determined by the system 30 from information in the taking into account known behavior patterns of the user. In other embodiments, the time windows could be user defined or a combination of any of the above.

The monitor mechanism 33 monitors each of the non-therapeutic activities included in the non-therapeutic activity information. In this embodiment, the monitor mechanism 33 receives data from the remote monitor mechanisms 33a, 33b, 33c and 33d as well data on other non-therapeutic activities such as whether the user making a telephone call. The monitor mechanism 33 assigns an activity score to the non-therapeutic activities being monitored, depending on whether the non-therapeutic activities are being performed or not. As discussed in more detail below, the activity scores are weighted in accordance with their likely effect of a message on the likelihood of the first user performing the therapeutic activity.

The system 30 then calculates a patient convenience index by summing the activity scores, and calculates a current threshold. The ranking processor 36 determines whether the patient convenience index is above the threshold.

In this embodiment, as discussed, the TV 33c can monitor what is being displayed on it and provide this information to the monitor mechanism 33. In this embodiment, the TV 33c can monitor whether the user is watching a pay per view (ppv) film, watching a preferred TV show, or watching other TV (i.e. not a ppv film or preferred show).

In this embodiment, it is considered likely that the user watching TV will have a negative impact on the likelihood of the first user taking the pill, with watching a ppv film (where it is assumed that the user, having paid for the content, is particularly engrossed) having the most negative impact. Hence, the weights of the activity scores for “watching TV” and “watching a ppv film” could be different.

In this embodiment, as discussed, the PC 33s can monitor what is being used on the PC, and provide this information to the monitor mechanism 33. In this embodiment, it is considered likely that the user using the internet will have a negative impact on the likelihood of the first user taking the pill.

The location sensors 33b can detect that the user is moving around the house (e.g. by detecting movement from one room to another within a time period). In this embodiment, it is considered likely that the user moving around will have a negative impact on the likelihood of the first user taking the pill. This is because the user in this embodiment is generally sedentary, and thus movement around the house is likely to have specific purpose (e.g. going to the bathroom).

The location sensors 33b can detect that the user is in their kitchen. As the pill dispenser 33a is in the user's kitchen, it is considered likely that the user being in the kitchen will have a strong positive impact on the likelihood of the first user taking the pill.

The NFC enabled pill dispenser 33a can detect that the user is proximate it, i.e. when the user is within the vicinity of or near to the NFC enabled pill dispenser. Being proximate the pill dispenser 33a is to have a very strong positive impact on the likelihood of the first user taking the pill.

The monitor mechanism 33 can detect that the user is making a phone call. It is considered that making a call has a strong negative impact on the likelihood of the first user taking the pill.

The patient convenience index is the sum of the weighted activity scores in this embodiment.

$$PCI = {\sum }_{activities} weight \times score$$

Four states of the user are considered as states 1, 2, 3 and 4 in Table 2.

TABLE 2

| | | Score in | Score in | Score in | Score in |
|---|---|---|---|---|---|
| Activity | Weights | State 1 | State 2 | State 3 | State 4 |
| Watching a | −3 | −3 | 0 | 0 | 0 |
| ppv film | | | | | |
| Watching a | −2 | 0 | −2 | 0 | 0 |
| preferred | | | | | |
| TV show | | | | | |
| Watching | −1 | 0 | 0 | −1 | 0 |
| other TV | | | | | |
| Using the | −1 | −1 | 0 | 0 | 0 |
| Internet | | | | | |
| Moving around | −1 | 0 | −1 | 0 | 0 |
| the house | | | | | |
| In kitchen | +2 | 0 | +2 | +2 | +2 |
| Near Pill | +4 | 0 | 0 | +4 | +4 |
| dispenser | | | | | |
| Making a | −10 | 0 | 0 | 0 | −10 |
| telephone call | | | | | |
| User convenience | | −4 | −1 | +5 | −4 |
| index | | | | | |

In state 1, the user is watching a ppv film and using the internet, while sitting down. The user is therefore not likely to want to be distracted by a message to take a pill. Hence, the patient convenience index is low (−4), indicating that a message of support to take the pill at this time is unlikely to be effective.

In state 2, the user the user is watching a preferred TV show, while moving around the house and in the kitchen. It can be inferred that because a preferred TV show is being played on TV and that the user has moved to the kitchen that the user is just getting something (e.g. a drink) before going to the preferred TV show. Hence, the patient convenience index, while higher than state 1, is low (−1), indicating that a message of support to take the pill at this time is unlikely to be effective.

In state 3, the user is watching another other (non-preferred) TV show, while in the kitchen and near the pill dispenser 33a and not moving around. It can be inferred that because the user has been in the kitchen for some time (as not moving) and that a non-preferred TV show is being played on TV that the user is in the kitchen to make or eat food. The user is also physically near the pill dispenser 33a (e.g. within 1 m). The user is therefore very likely to be susceptible to a reminder in this state, and hence the patient convenience index is high (+5) indicating that a message of support to take the pill at this time is likely to be effective.

In state 4, the user is in the kitchen and near the pill dispenser 33a and not moving around. The use is also taking a phone call. While being in the kitchen, being near the pill dispenser 33a, and not moving around factors have a strong positive effect on the efficacy of the reminder to take the pill, the fact that the user is making a telephone call has a strong negative effect of the efficacy of the reminder. Hence, the patient convenience index is low (−4) indicating that a reminder a message of support to take the pill at this time is unlikely to be effective.

After ranking the messages received from second users (in any of the ways described above), reminder processor 36 determines whether the user convenience index is greater than or equal to the threshold. If so, then the output mechanism 34 will output one or more of the messages to the firs user in consideration of the ranking.

Before outputting the message, the system 30 selects a message format. As discussed, in this embodiment, the output mechanism 34 is capable of providing an audible, vibrating and visual message, and the format of the reminder (e.g. purely audible, visible, or combination of audible, visual and vibrating) can vary. For example, the output format can vary according to ranking of the second user who sent the message and/or according to the message content.

In this embodiment, the user is provided with messages alerts related to their therapeutic regime at times that are considered to be appropriate for adhering to the therapeutic regime. This is done by delivering the messages when the user is carryout out (or not carrying out) certain non-therapeutic activities that are considered to have a positive or negative effect on the likelihood of the therapeutic activity being performed. Hence, such embodiments provide important benefits in ensuring that the user helps maintains their therapeutic regime.

Embodiments of the invention are suitable for messages relation to any part of a therapeutic regime, e.g. medication, exercise or any other task or activity recommended as part of the regime.

As a further example, consider an employee who is a bit overworked and his doctor has prescribed to take some moments of relaxation throughout the day. In this case the therapeutic regime comprises a treatment plan that simply includes the need to relax. Many individuals in such a situation may tend to forget about such a treatment plan in the flow of the normal workday. Embodiments of the invention (such as what is shown in FIG. 4) can help trigger the employee to relax at opportune moments. Such embodiments can ensure that his daily schedule allows for relaxation and trigger him to go for a walk or take a moment for meditation depending on his schedule and current activities.

For example, the employee could wear an activity sensor which measures his physical activity, with this activity sensor acting as a remote monitor mechanism in communication with a monitor mechanism in his tablet device. His tablet device could act as a central device in the system, and could store his calendar with his work appointments. The monitor mechanism in his tablet device could query his calendar to see when he is in a meeting (and therefore should not be bothered with messages from second users regarding relaxation). He could also wear a bracelet that measures his arousal levels, with this bracelet acting as a remote monitor mechanism in communication with a monitor mechanism in his tablet device.

In this case, a user convenience index could be calculated based on his calendar. Moments where there are no meetings could be considered convenient (e.g. +1) and moments that there are meetings are inconvenient (e.g. −1). The actual moment of finalizing the meeting can be measured based on a peak in physical activity from getting up from the chair and walking away from the meeting room to the desk (using the activity sensor). This could create a peak in the user convenience index (e.g. +4) since this is an opportune moment to trigger him for a relaxation moment (e.g., a message suggesting that he go for a walk or do a breathing exercise) after the meeting and right before he is starting a new activity (not a meeting but potentially some task behind his desk).

When the activity stops and he sits down behind his desk again the user convenience index drops to +1 again, when a new meeting starts it drops to −1.

The longer the employee has not taken a moment to relax, a “missed therapeutic activity cost” (i.e. the negative consequence of not performing the therapeutic activity) could be set to rise. Also based on the measured arousal, the missed therapeutic activity cost could rise when arousal levels are high for too long (due to stressful activities). In this example the missed therapeutic activity cost may vary with his stress levels, being higher when he is stressful for some time, and being lower when is in a relaxed state for some time (so regardless of predetermined windows).

In a fifth embodiment of the invention, a patient (i.e. the first user) consents to sharing aspects of care plan (i.e. a therapeutic regime) with third parties (i.e. second users). The care plan may be stored as therapeutic activity information as a flag or entry associated with a database record for the patent/care plan, and be subject to privacy controls which may be selected by the patient or their carer.

Third parties (i.e. second users) can sign up through web portal to receive updates for patient. Third parties may be invited based on the social media association with the first user, based on their e-mail record, based on their mobile phone call records, based on influence factors. For example those people who have had a similar condition and who live within a 10 mile radius of the patent, may be invited to join. On joining through the portal their login details will be associated with those of the first user, and certain permissions granted to view the patients medication adherence data in line the privacy settings selected by the first user or their carer. Third parties then receive copy of aspects of care plan.

In this embodiment, medication adherence events are identified by monitoring the first user and posted together with regular updates on medication adherence. In this context, a medication adherence event can be any event which is associated with the medication plan—an event can be positive (where the patient has complied with the plan) or negative (where there has been non-compliance). Examples include taking medication prescribed, not collecting a prescription on time, taking too much medication, missing a pill etc.

In this embodiment, the monitoring mechanism (e.g. diagnostic devices) which may be used to detect compliance includes such devices as (i) instrumented pill box, (ii) eMoney purchase transactions for collecting subscriptions, (iii) instrumented pills, (iv) patient entered data etc.

The likely influence between third parties and the first user are determined. In this embodiment, a number of different methods may be used to determine this including:
1) Past usefulness: Friends and family messages could be correlated based on past usefulness (e.g. determined by how long patient spends viewing messages, a direct rank by the first user or resulted actions by the patent.). Influence rank depends on strength on past usefulness. This could also be contextualized, e.g. different messages are useful for different things (pill taking, diet tips etc.)
2) Interpersonal Reactivity Index: Factors which determine empathy (which can be significant determinant of influence) based on Interpersonal Reactivity Index (and others). The questions of index to components may be assessed through electronic interactions (web forums etc.), such as:

i). Personal relationship with patient (same surname indicates family member etc.)

ii). Frequency of contact

iii). Relationship on social networks

iv). Similarity of conditions

v). Discussion of similar problems/issues or have/have had a similar care plan (can be used to determine the “Go-to” person(s)
3) Crowd-sourced voting: Yes/No voting by all users on influence of messages to the first user.

The outcome from each method may be ranked according to likely relevance using fixed criteria, or alternatively dynamically ranked according to the contextual influence between a user and a patient in a given situation.

The influence between each user and the first user is assessed—either statically, or dynamically, and ranked. The ranking is then associated with each second user. Then, third parties (i.e. second users) contribute messages of support to the first user.

Messages are entered by users giving support or advice to the patient. In some embodiments, if a second user who is ranked highly is not immediately available or has left no message, then they can be prompted by various means such as (i) text message, (ii)social media message, (iii) message to associate of the second user etc.

In some embodiments, if the highly ranked second user remains unavailable, then a flag can be set in the message scheduler (e.g. part of the output mechanism) to loop back to the step of prompting the highly ranked second user within a specific time window to try and maximize the chances of the second user sending a message.

In some embodiments, the web profile of the second user can be utilized such that their online history is used to predict their next online period, and—if this is within the time limits of a useful message posting—then a flag is set in the message schedule to prompt the highly ranked second user within a specific time window to try and maximize the chances of the second user sending a message.

In this embodiment, messages from second users are ranked according to (i) overall influence and (ii) contextual influence. Messages are ranked according to likely influence based on:

i. Influence of user creating message and first user

ii. Contextual influence between the second user and the first user's current situation

iii. Content of message and the first user's current situation

The time of delivery of messages to the first user is then scheduled. In this embodiment, the most appropriate time to communicate message to the first user computed (for example immediately after the event, immediately prior to the next possible occasion for the event to occur, before going to bed, during a moment of reflection) which may depend on the message contents and adherence event.

In this embodiment, the scheduler may function, for example, by modeling the desirability of delivering messages relating to specific adherence events at certain times, possibly by also considering the message contents.

In some embodiments, a looping structure can be incorporated to collect more messages, such that a loop back to the step of collecting messages from the second users during the time window when messages can be delivered is initiated under certain conditions (for example, more messages are required for the message scheduler)

In this embodiment, the elected messages are communicated through the communication device which—at the time the message is communicated—has most contextual influence with the first user. For example, all communication devices available to first user can be ranked according to the capability of the device to most influentially communicate the message to the first user. For example, the communication devices could be ranked as follows:

i. Identify all networked communication devices

ii. Derive activity of first user

iii. Calculate which communications device is most influence for first user's context

iv. Communicate message

c. Map message to communication device

i. The message with most influence can be mapped to the most influential communications device, and so forth. However variations in this mapping may be implemented.

In some embodiments, messages from high ranked second users may be sent to two or more communications devices, or be highlighted by the use of a larger font etc.

In some embodiments, an iterative feedback system may be incorporated so as to reward users who make acted on comments with a higher influence ranking, and reduce the ranking of those who do not.

To help explain the operation of the embodiments of the invention further, another example situation will be discussed.

In this example, the first user has Congestive heart failure (CHF), which is an inability of the heart to provide sufficient pump action to distribute blood flow to meet the needs of the body. CHF can cause a number of symptoms including shortness of breath, leg swelling, and exercise intolerance. Treatment for CHF commonly consists of lifestyle measures such as smoking cessation, light exercise including breathing protocols, decreased salt intake and other dietary changes, and medications. Sometimes it is treated with implanted devices (pacemakers or ventricular assist devices) and occasionally a heart transplant.

As such, CHF represents an example of a long term health condition that requires a therapeutic regime comprising a number of therapeutic activities. Non-adherence to the therapeutic regime is likely to lead to health problems.

For CHF the critical medications are typically beta blockers and diuretics. If these are being taken correctly (i.e. according to the user's therapeutic regime), then the user has the best chance of remaining stable with CHF. However, not taking the beta blockers can lead to arrhythmias, and not taking the diuretics can lead to lung edema. Both of these conditions can be life threatening and may require hospitalization. They are generally called “CHF decompensation”.

In this example, the first user will be referred to as Patient A. Patient A has CHF and is required to take beta blockers and diuretics. The taking of beta blockers and diuretics are each separate therapeutic activities in Patient A's therapeutic regime. In this example, the beta blockers proscribed to Patient A are new.

Patient A agrees to share their care plan with Users W, X, Y. Users W, X, Y, along with Patient A, use a web portal to share information with other others. In addition to Users W, X, Y, a large number of other users use the web portal and these other users also receive the care plan of Patient A.

User W has had the same condition, i.e. CHF, as Patient A. User W's therapeutic regime comprises taking the same diuretics as Patient A, but a different type of beta blocker.

User X has specific knowledge of the new beta blockers taken by Patient A but not experienced by User W.

User Y lives in the same village as Patient A.

Patient A receives a care plan from their consultant and agrees to share defined aspects of this plan with other users that use the web portal. Hence, the care plan including details of the therapeutic regime is stored on the web portal. Users W, X and Y can receive extracts from the plan via the web portal.

The influence between Patient A and Users W, X and Y is assessed using a variety of different techniques.

User W is rated as having the highest overall influence due to having suffered a similar condition previously and having been voted by other users as having previously produced supporting messages of a high level of influence with the patient.

User X is selected as having the greatest influence for the new medication which has not been experienced by User W and also scores highly based in the interpersonal reactivity index based on data mined from the web.

User Y is rated as having the great location based influence based on data mined from the web, and has also been voted by other users as having previously produced supporting messages of a high level of influence with the patient.

### Scenario 1

In this scenario, the system used by Patient A (i.e. the first user) has an instrumented pill taking as part of the monitoring mechanism. The instrumented pill taking system indicates that Patient A has just taken the first dose of the new medicine which creates an adherence event.

User X, as the person with greatest contextual influence for the new medicine is prompted to leave a message and all other users are free to also leave message.

User X is initially unavailable, but eventually leaves a message 2 hours after the adherence event The message of User X is ranked highest due to the contextual influence, with User W the next highest. There are also 10 other messages of support from other users.

In this scenario, the communication means available to Patient A are mobile device text message, mobile device e-mail message, mobile device on-screen portal message, television message and pill-box on screen message.

The communication means are ranked according to their context with the patient event. The ranking is (1) pill-box screen message, (2) television message, (3) mobile device text message.

The message from User X is displayed on the pill-box just before the patient goes to bed, which has been scheduled as being the mostly influential time on Patient A, and all 12 (10+2) messages are scheduled and displayed on the television during an advertising break, or break between programs, which is being viewed by Patient A.

### Scenario 2

In this scenario, eMoney transaction data indicates that Patient A is late collecting their pill prescription from the local pharmacy, which creates an adherence event.

User Y, as the person with greatest contextual influence for location is prompted to leave a message and all other users are free to also leave message. The message of User Y is ranked highest due to the contextual influence, with User W the next highest. There are also 5 other messages of support.

In this scenario, the communication means available to Patient A are mobile device text message, mobile device e-mail message, mobile device audio message, television message and pill-box on screen message.

The communication means are ranked according to their context with the patient event. The ranking is (1) mobile device text message, (2) mobile device on-screen portal message, (3) television message. Mobile devices means of communication are ranked highest as the patient is not currently watching television, but mobile phone location data indicates they are moving within their home.

The message from User Y is sent as a text message, and all 12 (10+2) messages are loaded as an on-screen portal message with ranking such that Y and W are most visible (larger font, list first etc.)

Another embodiment of the invention will now be described. In this embodiment, users are categorized into one of a predetermined number of psychological profiles. The information on the psychological profile can be stored in the therapeutic regime datastore, or in another storage unit of the system.

As a result, the second users can be ranked according to the psychological profile of the first user to rank the second users. In other words, those second users with compatible profiles (which may be the same profile type or a different profile type depending on the profile type of the first user) can be ranked higher.

In some embodiments, the ranking processor 16 is arranged to use the communications method used by the second users to send messages to the first user in the ranking. This can be used along with the profile of the first user to determine the ranking of the second users.

As a result, the ranking of the second users can be determined based on the delivery modes that second user has available and the match these have with the psychological profile of the first user (e.g. more personal delivery vs. less personal delivery) as well as and the relationship he has with the patient and the communication style he has.

It will be appreciated that the psychological profile of the first user could be used to rank the second users in a number of different ways.

In some embodiments, the user datastore can be arranged to store information on the psychological profiles of the second users. In some embodiments, the ranking processor can use the psychological profiles of the second users to determine the ranking. For example, ranking processor could use the psychological profile of the first user and the psychological profiles of the second users to determine the ranking.

In some embodiments, the ranking processor could use the psychological profile of the first user, the psychological profiles of the second users, and the communication method used by (or available to) the second users to determine the ranking.

As discussed, embodiments of the invention can provide a system for messaging, the system comprising: a therapeutic regime datastore arranged to store therapeutic activity information including information on therapeutic activities forming part of a therapeutic regime of a first user, the therapeutic regime of the first user relating to a health condition of the first user; a user datastore arranged to store information on a plurality of second users; a monitor mechanism arranged to monitor the first user to determine if the first user performs a therapeutic activity for which therapeutic activity information is stored in the therapeutic regime datastore and to produce an adherence result for that therapeutic activity based on the determination; an output mechanism arranged to output information to the second users regarding the adherence result; a receiver mechanism arranged to receive messages from the second users to the first user relating to the adherence result; a ranking processor arranged to assign a ranking score to each of the second users, with the ranking score relating to the likely influence between a said second user and the first user;

wherein the output mechanism is arranged to output one or more messages from the second users to the first user in consideration of the ranking scores. In embodiments, the likely influence can be determined by a number of different techniques either alone or in combination. For example, it can be determined by considering any one or combination of: the amount of time the first user spends viewing a message from a second user; direct ranking of second users by the first user; analyzing the context of a message and determined how suitable it is for a certain health condition of the first user; a personal relationship between a second user with the first user; frequency of contact between a second user and the first user, etc. In some embodiments of the invention an influence score can be calculated or determined for each of these techniques, and that the ranking score is then in turn determined by taking all the different influence scores into account.

As described above, embodiments of the invention provide an improved system and method for messaging a user. Such a system provides messages (e.g. messages of support) to the first user from second users. The ranking of the messages from the second users and the output of the messages in consideration of this ranking ensures that the most important or most relevant messages are given the appropriate attention by the first user. This avoids the technical issue of the user having a great many messages to sift through to get to the important messages. It also helps ensure that important messages are not missed by the user. In a number of the examples above, the first user has a long term health condition. It will, of course, be appreciated that embodiments of the invention are equally applicable to any condition, be it a long term condition or a short term one.

It will be appreciated that the hardware used by embodiments of the invention can take a number of different forms. For example, all the components of the system could be provided by a single device (e.g. the example of FIG. 2 in conjunction with a web portal), or different components of the system could be provided on separate devices. Examples of such arrangements are the system of FIG. 4, in which a number of the components of the respective systems are provided on a device, whereas other components are provided on remote devices (with “remote” in this context meaning not part of the device, but communicable with the device). More generally, it will be appreciated that embodiments of the invention can provide a system that comprises one device or several devices in communication.

It will be appreciated that the term “comprising” does not exclude other elements or steps and that the indefinite article “a” or “an” does not exclude a plurality. A single processor may fulfill the functions of several items recited in the claims. The mere fact that certain measures are recited in mutually different dependent claims does not indicate that a combination of these measures cannot be used to an advantage. Any reference signs in the claims should not be construed as limiting the scope of the claims.

Although claims have been formulated in this application to particular combinations of features, it should be understood that the scope of the disclosure of the present invention also includes any novel features or any novel combinations of features disclosed herein either explicitly or implicitly or any generalization thereof, whether or not it relates to the same invention as presently claimed in any claim and whether or not it mitigates any or all of the same technical problems as does the parent invention. The applicants hereby give notice that new claims may be formulated to such features and/or combinations of features during the prosecution of the present application or of any further application derived therefrom.

1. A system for messaging, the system comprising:
a therapeutic regime datastore arranged to store therapeutic activity information including information on therapeutic activities forming part of a therapeutic regime of a first user, the therapeutic regime of the first user relating to a health condition of the first user;
a user datastore arranged to store information on a plurality of second users;
a monitor mechanism arranged to monitor the first user to determine if the first user performs a therapeutic activity for which therapeutic activity information is stored in the therapeutic regime datastore and to produce an adherence result for that therapeutic activity based on the determination;
an output mechanism arranged to output information to the second users regarding the adherence result;
a receiver mechanism arranged to receive messages from the second users to the first user relating to the adherence result;
a ranking processor arranged to assign a ranking score to each of the second users, with the ranking score relating to the likely influence between a said second user and the first user;
wherein the output mechanism is arranged to output one or more messages from the second users to the first user in consideration of the ranking scores.

2. A system according to claim 1, wherein the ranking score relates to the likely influence of the said second user on the adherence of the first user to the therapeutic regime.

3. A system according to claim 1, wherein the monitor mechanism is arranged to determine if the therapeutic activity is subsequently performed by the first user following the output of a said message from one of the second users;
wherein the user datastore is arranged to store information on which second users' messages are effective in causing the therapeutic activity to be performed following the output of the messages; and
wherein the ranking processor is arranged to assign higher ranking scores to those second users whose messages are effective in causing the therapeutic activity to be performed following the output of the messages.

4. A system according to claim 1, wherein the user datastore is arranged to store information on the relationships between the plurality of second users and the first user, and wherein the ranking processor is arranged to assign higher ranking scores to those second users with closer relationships to the first user; and/or
wherein the user datastore is arranged to store information on location proximity between the plurality of second users and the first user, and wherein the ranking processor is arranged to assign higher ranking scores to those second users who are near to the first user; and/or
wherein the user datastore is arranged to store information on the frequency of contact between the each of the second users and the first user, and wherein the ranking processor is arranged to assign higher ranking scores to those second users with more frequent contact with the first user; and/or
wherein the user datastore is arranged to store information on health conditions of the second users, and wherein the ranking processor is arranged to assign higher ranking scores to those second users with similar health conditions to the health condition of the first user; and/or
wherein the user datastore is arranged to store information on therapeutic activities carried out by the second users, and the ranking processor is arranged to assign higher ranking scores to those second users who carry out similar therapeutic activities to the therapeutic activity of the first user.

5. A system according to claim 1, wherein the monitor mechanism is arranged to determine how long the first user spends viewing messages from each of the second users, and to store this information in the user datastore; and
wherein the ranking processor is arranged to assign higher ranking scores to those second users whose messages are viewed for longer by the first user.

6. A system according to claim 1, further comprising:
a user input arranged to receive an input from the user indicating how useful the first user found each message from the second users in aiding adherence to the therapeutic regime, wherein said input is used in the determining of the ranking scores.

7. A system according to claim 1, wherein the ranking processor is arranged to assign different ranking scores to the second users depending on the nature of the adherence result.

8. A system according to claim 1, wherein the ranking processor is arranged to assign different ranking scores to the second users depending on the content of the messages sent by the second users.

9. A system according to claim 1, wherein the ranking processor is arranged to compare the ranking scores of those second users for which messages are received with a stored threshold, and
wherein if the ranking scores of those second users for which messages are received are below the stored threshold, the output mechanism is arranged to output a message prompt to second users whose ranking scores are above the stored threshold;
optionally wherein following the output of the message prompt, if no messages are received from those second users whose ranking scores are above the stored threshold within a predetermined time window, the output mechanism is arranged to output a further message prompt to those second users whose ranking scores are above the stored threshold.

10. A system according to claim 1, further comprising:
an activity datastore arranged to store non-therapeutic activity information comprising information on non-therapeutic activities that are considered to have an effect on the impact of the message;
wherein the monitor mechanism is arranged to monitor the user to determine if the user is performing one or more non-therapeutic activities for which non-therapeutic activity information is stored in the activity datastore and to produce a monitoring result based on the determination;
wherein the ranking processor is arranged to determine when to send the first user the one or more messages from the second users based on the monitoring result, wherein the ranking processor is arranged to compare the monitoring result to a stored parameter;
wherein the output mechanism is arranged to time the output the one or more messages from the second users to the first user on the basis of the comparison of the monitoring result and the stored parameter; optionally wherein the impact of the message relates to the likelihood of the first user performing the therapeutic activity.

11. A system according to claim 10, wherein the stored parameter is a threshold, and the output mechanism is arranged to output the one or more messages from the second users to the first user when the monitoring result meets or exceeds the threshold.

12. A system according to claim 10, wherein the monitor mechanism is arranged to monitor each activity in the activity information, and to assign an activity score based on whether that activity is being performed;
optionally wherein the monitoring result is the sum of the activity scores, further optionally wherein the monitor mechanism is arranged to assign different weight values to different activities scores.

13. A system according to claim 1, wherein the output mechanism comprises a number of devices capable of outputting the messages to the first user, and wherein the ranking processor is arranged to determine which of the said devices to use to output each message to the user based on the therapeutic activity to which each message relates to.

14. A system according to claim 1, wherein the ranking processor is arranged to use the communications method used by the second users to send messages to the first user in the ranking.

15. A system according to claim 14, wherein the therapeutic regime datastore is arranged to store information relating to a psychological profile of the first user, and wherein the ranking processor is arranged to use the psychological profile of the first user to rank the second users.
